(19) United States
(12) Patent Application Publication
(10) Pub. No.: US 2026/0105646 A1
(43) Pub. Date: Apr. 16, 2026

(54) ZERO SHOT CONTENT CUSTOMIZATION AND COMPOSITION

(71) Applicant: ADOBE INC., SAN JOSE, CA (US)

(72) Inventors: Pranav Vineet Aggarwal, Santa Clara, CA (US); Aashish Kumar Misraa, Santa Clara, CA (US); He Zhang, Santa Clara, CA (US); Soo Ye Kim, San Jose, CA (US); Wei Xiong, San Jose, CA (US); Hareesh Ravi, San Jose, CA (US); Jing Shi, San Jose, CA (US); Midhun Harikumar, Sunnyvale, CA (US); Zhe Lin, Clyde Hill, WA (US); Elya Shechtman, Seattle, WA (US)

(21) Appl. No.: 18/913,107

(22) Filed: Oct. 11, 2024

(51) Int. Cl. G06T 11/00; G06F 40/289; G06T 5/60; G06T 5/70; G06T 7/194; G06V 30/19

(52) U.S. Cl. CPC G06T 11/00; G06T 5/60; G06T 5/70; G06T 7/194; G06V 30/19147; G06F 40/289

(57) ABSTRACT

A method, apparatus, non-transitory computer readable medium, and system for image generation include obtaining an object prompt and a background prompt, wherein the object prompt describes an object with a target effect and the background prompt describes a scene. A noise input is generated based on the object prompt and the background prompt, where the noise input indicates a location of the object within the scene. An image generation model generates a synthetic image based on the object prompt, the background prompt, and the noise input. The synthetic image depicts the object at the location within the scene with the target effect applied to the object.

### BACKGROUND

The following relates generally to image processing, and more specifically to image generation using machine learning. Digital image processing refers to the use of a computer to edit a digital image using an algorithm or a processing network. In some cases, image processing software can be used for various tasks, such as image editing, image restoration, image generation, etc. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, involves the use of diffusion models to synthesize images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data.

### SUMMARY

The present disclosure describes systems and methods for image generation. Embodiments of the present disclosure include an image generation apparatus that receives a reference image, a text prompt, and a background image. The reference image depicts an object (also referred to as a foreground object or an identity input), the text prompt describes a target effect for the object, and the background image depicts a scene. The image generation apparatus specifies a mask channel corresponding to an object mask indicating a location of the object in the scene. Specifically, the noise input includes a channel corresponding to the object mask. Additional masked image channels are used to capture the scene of the background image and a location of the object within the scene (e.g., a location to be inserted). In some cases, a noise input is generated based on the object and the background image, such that the noise input indicates a location of the object within the scene. An image generation model (e.g., a diffusion U-Net) generates a synthetic image based on the reference image, the text prompt, the background image, and the noise input. The synthetic image depicts the object at the location within the scene with the target effect applied to the object.

A method, apparatus, non-transitory computer readable medium, and system for image generation are described. One or more embodiments of the method, apparatus, non-transitory computer readable medium, and system include obtaining an object prompt and a background image, wherein the object prompt describes an object with a target effect and the background image depicts a scene; generating a noise input based on the object prompt and the background image, wherein the noise input indicates a location of the object within the scene; and generating, using an image generation model, a synthetic image based on the object prompt, the background image, and the noise input, wherein the synthetic image depicts the object at the location within the scene with the target effect applied to the object.

A method, apparatus, non-transitory computer readable medium, and system for image generation are described. One or more embodiments of the method, apparatus, non-transitory computer readable medium, and system include obtaining a training set including a training reference image and a training text prompt, wherein the training reference image depicts an object and the training text prompt describes a target effect for the object; generating a noise input based on the training reference image and the training text prompt, wherein the noise input indicates a location of the object; and training, using the training set, an image generation model to generate a synthetic image based on the noise input, wherein the synthetic image depicts the object at the location with the target effect applied to the object.

An apparatus, system, and method for image generation are described. One or more embodiments of the apparatus, system, and method include a memory component; a processing device coupled to the memory component, the processing device configured to perform operations comprising generating a noise input based on a reference image and a background image, wherein the noise input indicates a location of an object from the reference image within a scene from the background image; and generating, using an image generation model, a synthetic image based on the reference image, a text prompt, the background image, and the noise input, wherein the synthetic image depicts the object at the location within the scene with a target effect from the text prompt applied to the object.

### BRIEF DESCRIPTION OF THE DRAWINGS

FIG. 1 shows an example of an image generation system according to aspects of the present disclosure.

FIG. 2 shows an example of a method for conditional media generation according to aspects of the present disclosure.

FIG. 3 shows an example of text-guided object insertion according to aspects of the present disclosure.

FIG. 4 shows an example of object insertion without text guidance according to aspects of the present disclosure.

FIG. 5 shows an example of text-to-image generation according to aspects of the present disclosure.

FIG. 6 shows an example of image generation according to aspects of the present disclosure.

FIG. 7 shows an example of controlling the effect of identity modality according to aspects of the present disclosure.

FIG. 8 shows an example of a method for image generation according to aspects of the present disclosure.

FIG. 9 shows an example of an image generation apparatus according to aspects of the present disclosure.

FIGS. 10-13 show examples of an image generation model according to aspects of the present disclosure.

FIG. 14 shows an example of a guided latent diffusion model according to aspects of the present disclosure.

FIG. 15 shows an example of a U-Net architecture according to aspects of the present disclosure.

FIG. 16 shows an example of a diffusion process according to aspects of the present disclosure.

FIG. 17 shows an example of a method for image generation according to aspects of the present disclosure.

FIG. 18 shows an example of a method for training an image generation model according to aspects of the present disclosure.

FIG. 19 shows an example of a method for training a diffusion model according to aspects of the present disclosure.

FIG. 20 shows an example of a step-by-step procedure for training a machine learning model according to aspects of the present disclosure.

FIG. 21 shows an example of a computing device for image generation according to aspects of the present disclosure.

### DETAILED DESCRIPTION

The present disclosure describes systems and methods for image generation. Embodiments of the present disclosure include an image generation apparatus that receives a reference image, a text prompt, and a background image. The reference image depicts an object (also referred to as a foreground object or an identity input), the text prompt describes a target effect for the object, and the background image depicts a scene. The image generation apparatus specifies a mask channel corresponding to an object mask indicating a location of the object in the scene. Specifically, the noise input includes a channel corresponding to the object mask. Additional masked image channels are used to capture the scene of the background image and a location of the object within the scene (e.g., a location to be inserted). In some cases, a noise input is generated based on the object and the background image, such that the noise input indicates a location of the object within the scene. An image generation model (e.g., a diffusion U-Net) generates a synthetic image based on the reference image, the text prompt, the background image, and the noise input. The synthetic image depicts the object at the location within the scene with the target effect applied to the object.

Diffusion models are a class of generative neural networks that can be trained to generate new data with features similar to features found in training data. Diffusion models can be used in image synthesis, image completion tasks, etc. Conventional models are designed and trained to handle a single task. For example, text-to-image generators such as Stable Diffusion handle text-to-image generation. Certain specialty models handle custom image generation, localized image editing, or object insertion separately. Therefore, conventional models are trained to handle a specific type of task, and they lack the ability to handle the above tasks as a unified model.

Embodiments of the present disclosure include an image generation apparatus that takes a reference image, a text prompt, and a background image as inputs. The reference image depicts an object, the text prompt describes a target effect for the object, and the background image depicts a scene. The image generation apparatus generates a noise input based on the object and the background image. The noise input indicates the location of the object within the scene. In some examples, the image generation apparatus obtains an object mask indicating the location of the object in the scene, wherein the noise input includes a channel corresponding to the object mask. Additionally, the image generation apparatus obtains one or more channels corresponding to a masked background image.

At inference time, the object mask, the masked background image, and a noise map are fed to an image generation model (e.g., a diffusion model including a U-Net). The diffusion model generates a synthetic image based on the reference image, the text prompt, the background image, and the noise input. The synthetic image depicts the object at the location within the scene with the target effect applied to the object.

In an embodiment, a pre-trained image generation model is fine-tuned with mask channels. In some examples, the channels are dropped 50% of the time by setting the mask channels to 0s (e.g., 50% of the masks are dropped). The training process includes dropping text, identity and image branches based on pre-determined drop probabilities, so the image generation model learns to generate images based on a text prompt, a reference/identity image, a background image, or any combination thereof, during inference. In some examples, the training process includes jointly training the image generation model (e.g., U-Net), an identity encoder, a text encoder, and an image encoder. During training, for a significant percentage of the time the image generation model receives a reference image (an identity input) with or without text tokens inside the cross-attention block while the mask channels are also provided. This enables the image generation model to understand text and identity for various tasks such as global and local generation and editing.

The present disclosure describes systems and methods that improve on conventional image generation models by increasing the efficiency of handling different types of image generation tasks using a unified machine learning model. For example, users can use the trained image generation model described in the present disclosure to handle text-to-image generation, masked region filling, custom text-to-image generation, object insertion, localized editing, etc. Embodiments of the present disclosure achieve this improved efficiency by jointly training a diffusion model, a text encoder, an image encoder, and an identity encoder. The text encoder, the image encoder, and the identity encoder encode a text prompt, a background image, and a reference/identity image, respectively. Additionally, the training process involves identifying a pre-determined dropping ratio and dropping the object mask based on the pre-determined dropping ratio by setting values of the object mask to zeros (e.g., 50% of the masks are dropped). Accordingly, model efficiency is improved.

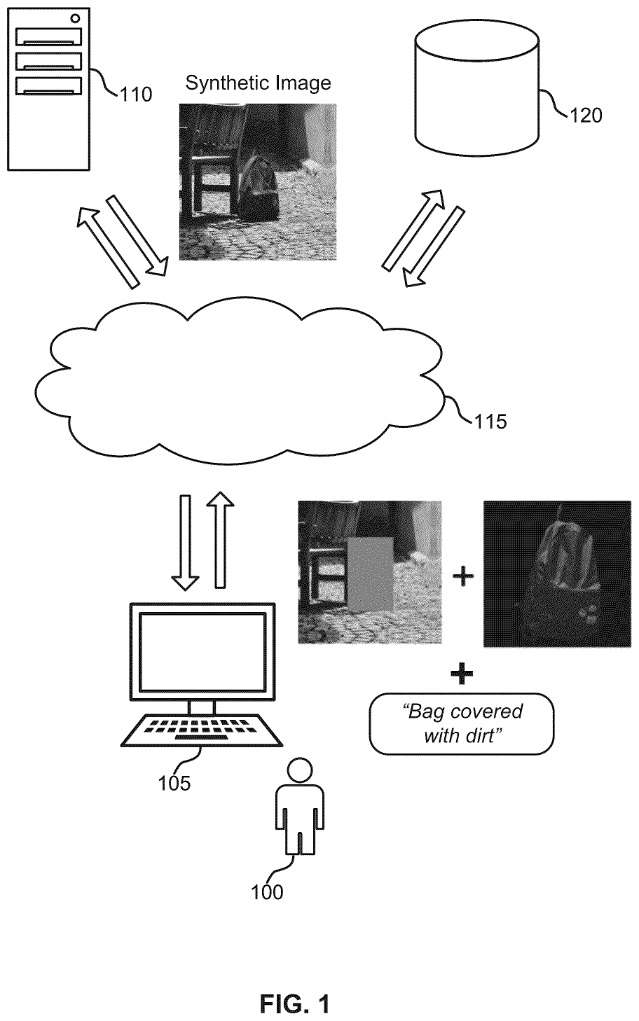

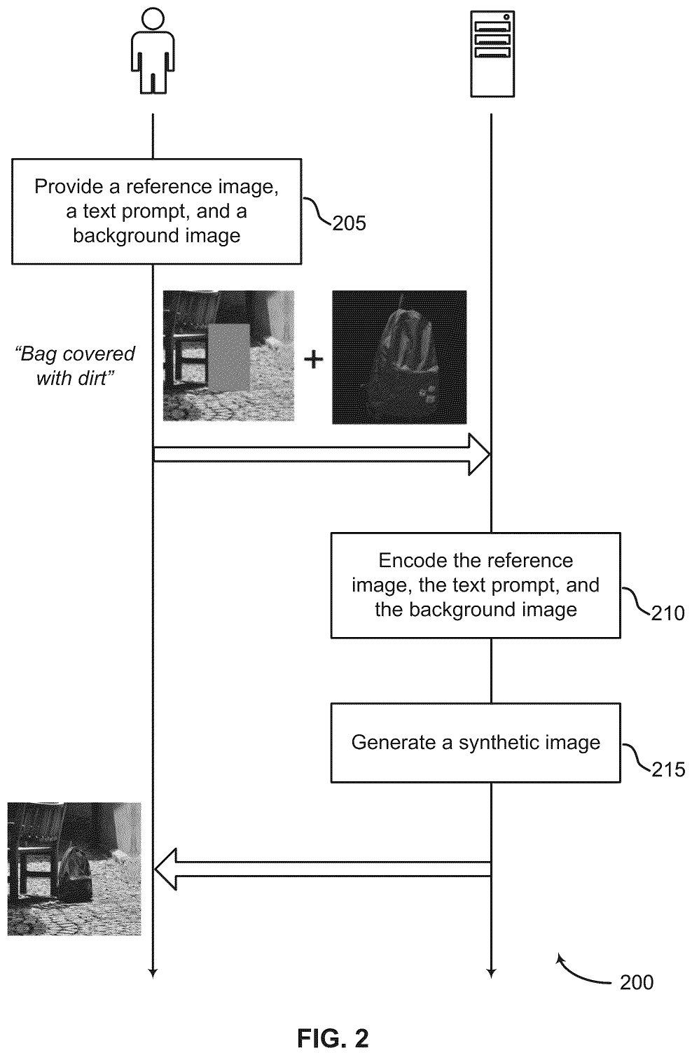

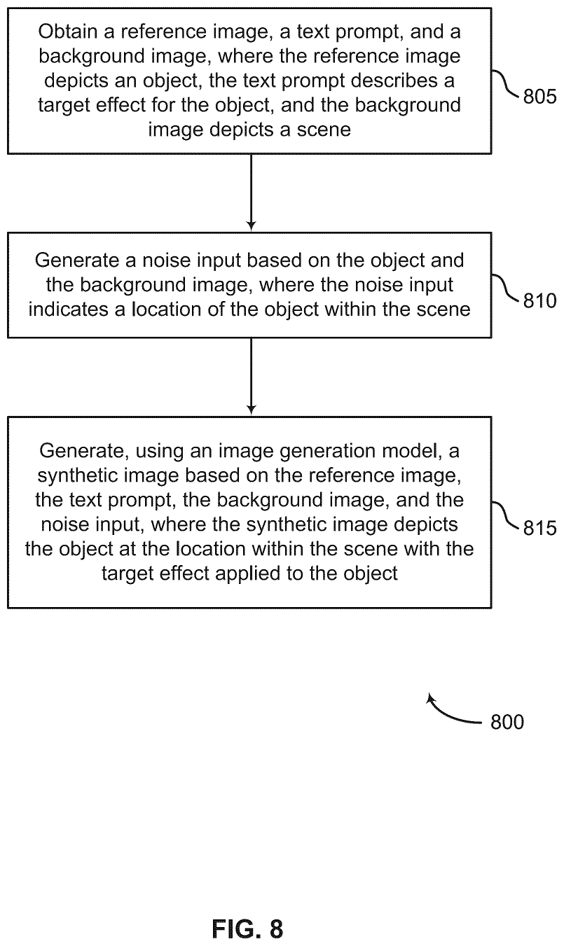

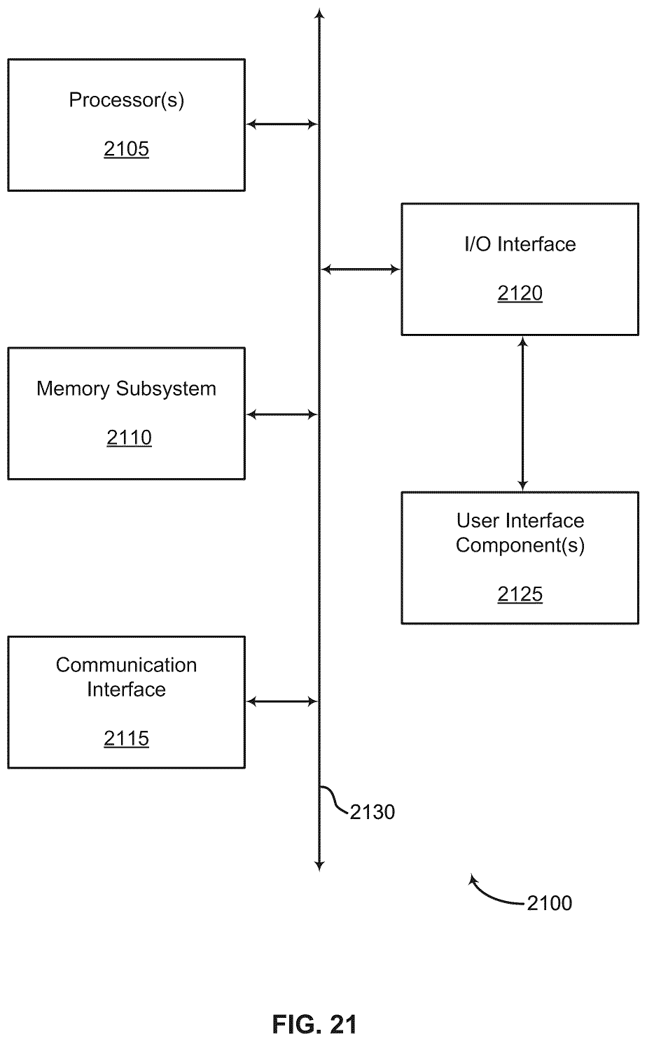

Examples of application in image generation context are provided with reference to FIGS. 2-7. Details regarding the architecture of an example image generation system are provided with reference to FIGS. 1 and 9-16. Details regarding the image generation process are provided with reference to FIG. 8. Details regarding an example of training an image generation model are provided with reference to FIGS. and 17-20. Details regarding a computing device for image generation are provided with reference to FIG. 21.

### Image Generation

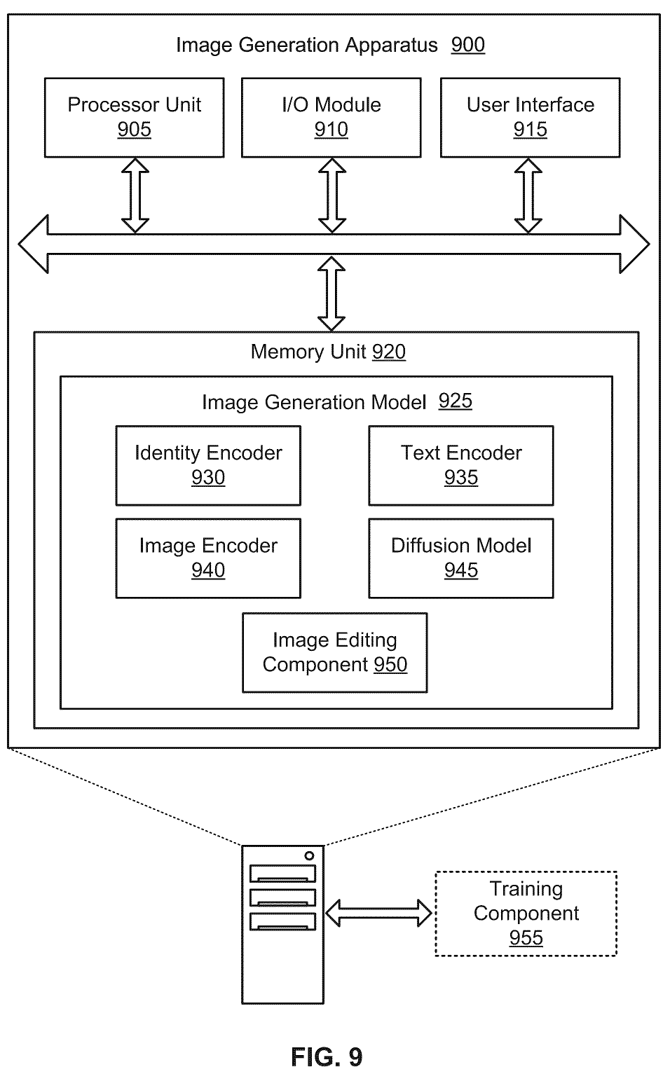

FIG. 1 shows an example of an image generation system according to aspects of the present disclosure. The example shown includes user 100, user device 105, image generation apparatus 110, cloud 115, and database 120. Image generation apparatus 110 is an example of, or includes aspects of, the corresponding element described with reference to FIG. 9.

In an example shown in FIG. 1, a text prompt is provided by user 100. For example, the text prompt is “Bag covered with dirt”. The text prompt describes a target effect for the object (e.g., covering the bag with dirt). User 100 uploads a reference image indicating a target object (e.g., the foreground “bag” on a black background). In some cases, the reference image is also referred to as an identity image or identity input. The text prompt, the reference image, and a background image are transmitted to image generation apparatus 110, e.g., via user device 105 and cloud 115. In some examples, the background image depicts a scene and includes an object mask (e.g., a bounding box) indicating the location of the target object in the scene.

Image generation apparatus 110 generates a noise input based on the object and the background image, where the noise input indicates a location of the object within the scene. The noise input includes a channel corresponding to the object mask. Image generation apparatus 110 generates, using an image generation model, a synthetic image based on the reference image, the text prompt, the background image, and the noise input. The synthetic image depicts the object at the location within the scene with the target effect applied to the object. Image generation apparatus 110 returns one or more synthetic images to user 100 via cloud 115 and user device 105.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the image processing application on user device 105 may include functions of image generation apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

Image generation apparatus 110 includes a computer-implemented network comprising an image encoder and a diffusion model. Image generation apparatus 110 may also include a processor unit, a memory unit, an I/O module, and a user interface. A training component may be implemented on an apparatus other than image generation apparatus 110. The training component is used to train an image generation model. Additionally, image generation apparatus 110 can communicate with database 120 via cloud 115. In some cases, the architecture of the image generation network is also referred to as a network, a machine learning model, or a network model. Further detail regarding the architecture of image generation apparatus 110 is provided with reference to FIGS. 9-16. Further detail regarding the operation of image generation apparatus 110 is provided with reference to FIGS. 2 and 8.

In some cases, image generation apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., training dataset including training image pairs) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

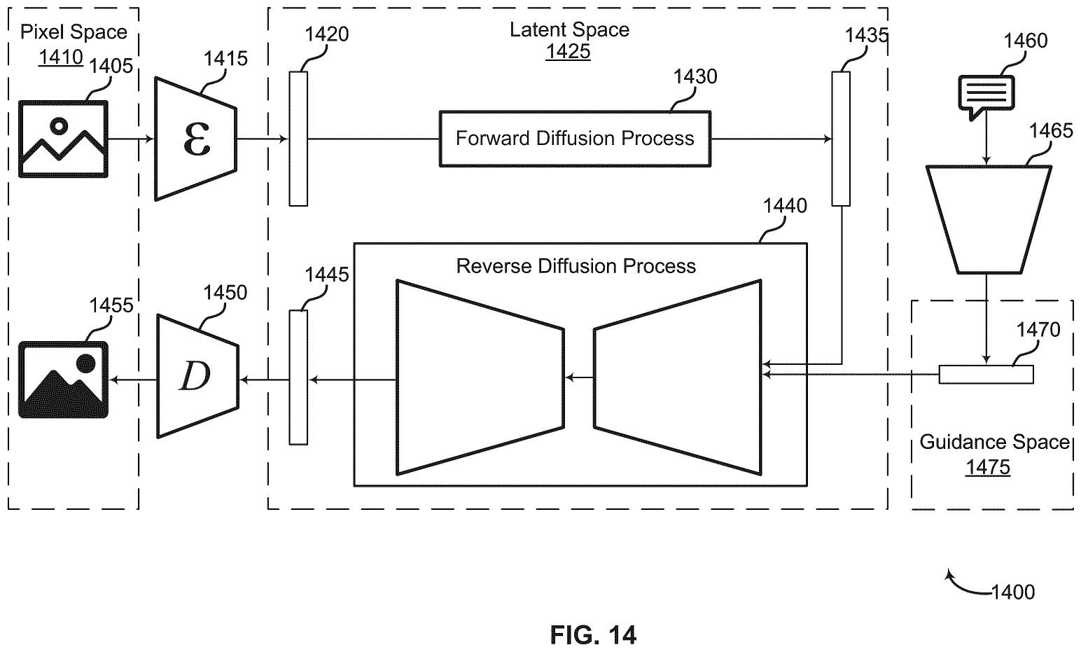

FIG. 2 shows an example of a method 200 for conditional media generation according to aspects of the present disclosure. In some examples, method 200 describes an operation of the image generation model 925 described with reference to FIG. 9 such as an application of the guided latent diffusion model 1400 described with reference to FIG. 14. In some examples, these operations are performed by a system including a processor executing a set of codes to control functional elements of an apparatus such as the image generation apparatus described in FIGS. 1 and 9.

Additionally or alternatively, steps of the method 200 may be performed using special-purpose hardware. Generally, these operations are performed according to the methods and processes described in accordance with aspects of the present disclosure. In some cases, the operations described herein are composed of various substeps or are performed in conjunction with other operations.

At operation 205, the system provides a reference image, a text prompt, and a background image. In some cases, the operations of this step refer to, or may be performed by, a user as described with reference to FIG. 1. For example, the reference image is an image of a bag, the text prompt is “Bag covered in dirt”, and the background image is a depiction of an outdoor scene having a chair on the ground.

In some examples, a user provides a reference image (or a foreground image) describing content to be included in a generated media item (e.g., a target object in a synthetic image or in a composite image). For example, the user may provide a reference image depicting a “bag” object and a background image depicting a scene comprising a chair on the ground. In some examples, guidance can be provided in a form such as text, an image, a sketch, or a layout.

At operation 210, the system encodes the reference image, the text prompt, and the background image. In some cases, the operations of this step refer to, or may be performed by, an image generation apparatus as described with reference to FIGS. 1 and 9.

The image generation apparatus converts the reference image (or other guidance) into a conditional guidance vector or other multi-dimensional representation. In some cases, the multi-dimensional representation may be referred to as an identity-preserving embedding. For example, the reference image (or the foreground image) may be converted into a vector or a series of vectors using a transformer model, or a multi-modal encoder. In some cases, the encoder for the conditional guidance vector is trained independently of the diffusion model.

At operation 215, the system generates a synthetic image. In some cases, the operations of this step refer to, or may be performed by, an image generation apparatus as described with reference to FIGS. 1 and 9. For example, the synthetic image depicts a scene including the bag from the reference image covered in dirt in the context of the outdoor scene of the background image.

In some cases, a noise map is initialized that includes random noise. The noise map may be in a pixel space or a latent space. By initializing a media item with random noise, different variations of a media item including the content described by the conditional guidance can be generated.

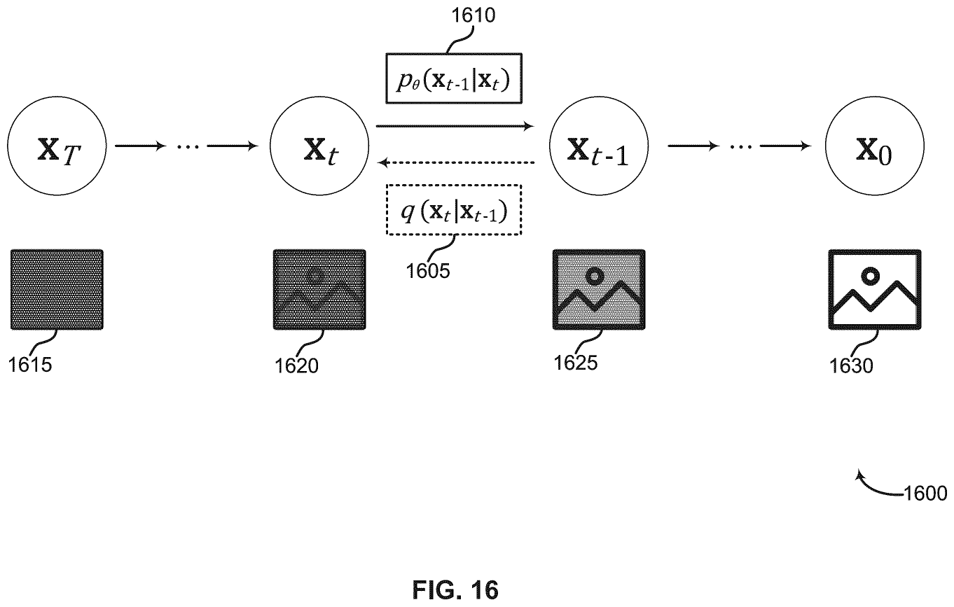

The image generation apparatus generates a media item (e.g., a synthetic image or a composite image) based on the noise map and the conditional guidance vector. For example, the media item may be generated using a reverse diffusion process as described with reference to FIGS. 14 and 16.

In some cases, the synthetic image includes elements from a reference image, a text prompt, a background image, or any combination thereof. The synthetic image harmonizes the elements of the reference image, the text prompt, and the background image to obtain a cohesive generated image.

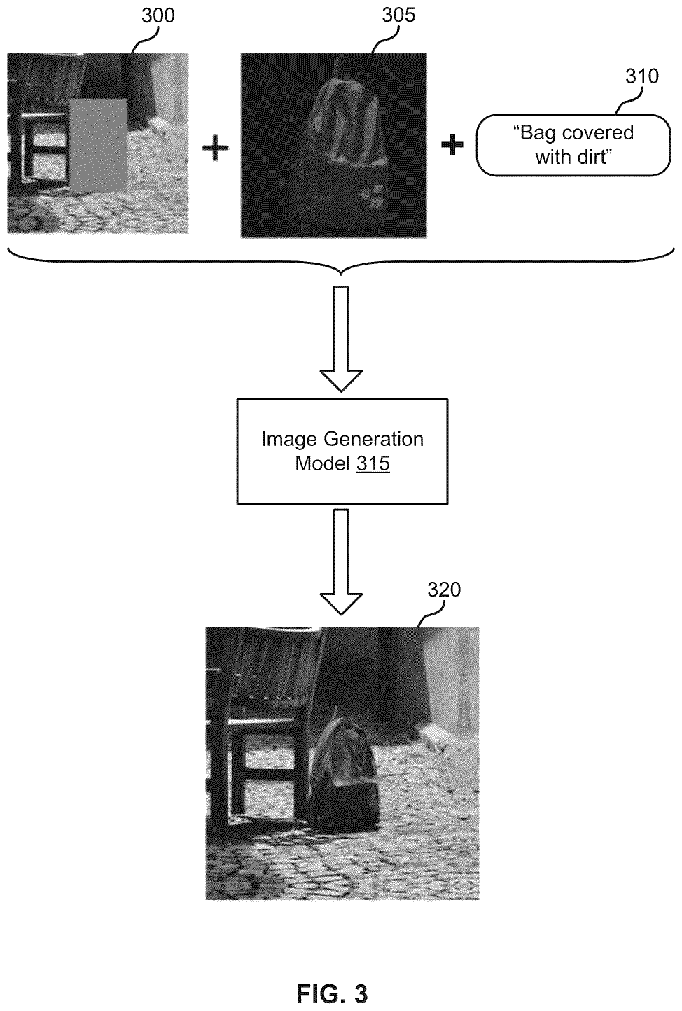

FIG. 3 shows an example of text-guided object insertion according to aspects of the present disclosure. The example shown includes background image 300, reference image 305, text prompt 310, image generation model 315, and synthetic image 320.

According to some embodiments, image generation model 315 obtains a reference image 305, a text prompt 310, and a background image 300 as input. The reference image 305 depicts an object, the text prompt 310 describes a target effect for the object, and the background image 300 depicts a scene. In some examples, image generation model 315 generates a noise input based on the object and the background image 300, where the noise input indicates a location of the object within the scene. Image generation model 315 generates a synthetic image 320 based on the reference image 305, the text prompt 310, the background image 300, and the noise input. The synthetic image 320 depicts the object at the location within the scene with the target effect applied to the object.

In some examples, image generation model 315 obtains an object mask indicating the location of the object in the scene, where the noise input includes a channel corresponding to the object mask. In some examples, image generation model 315 denoises the noise input based on the reference image 305 and the text prompt 310. In some examples, image generation model 315 obtains an identity preservation value. Image generation model 315 combines a first attention weight corresponding to the reference image 305 and a second attention weight corresponding to the text prompt 310 based on the identity preservation value. In some examples, image generation model 315 generates a noise input based on the object and the ground-truth image at training, where the noise input indicates a location of the object within the scene.

In an embodiment, image generation model 315 (comprising parameters stored in an at least one memory) is trained to generate a noise input based on a reference image 305 and a background image 300, where the noise input indicates a location of an object from the reference image 305 within a scene from the background image 300, and to generate a synthetic image 320 based on the reference image 305, a text prompt 310, the background image 300, and the noise input. The synthetic image 320 depicts the object at the location within the scene with a target effect from the text prompt 310 applied to the object.

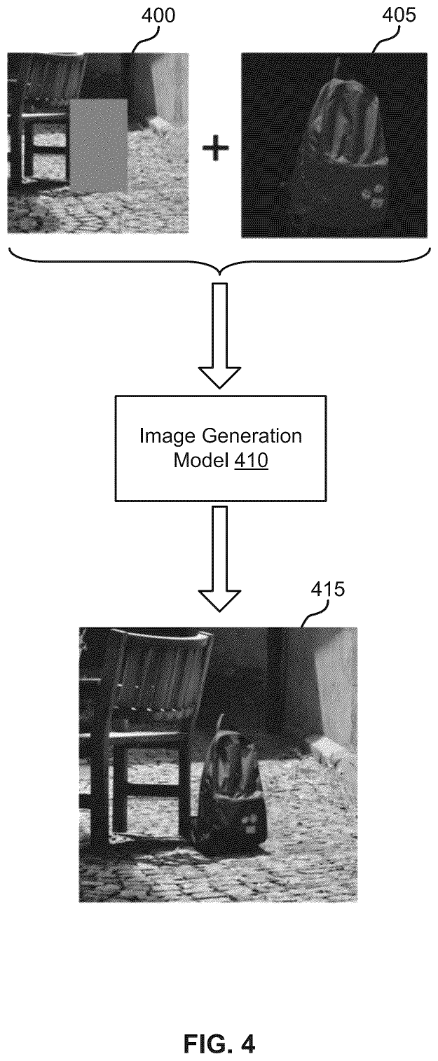

In some examples, the image generation model 315 includes a diffusion model. Image generation model 315 is an example of, or includes aspects of, the corresponding element described with reference to FIGS. 4-6, 9, 10, and 13.

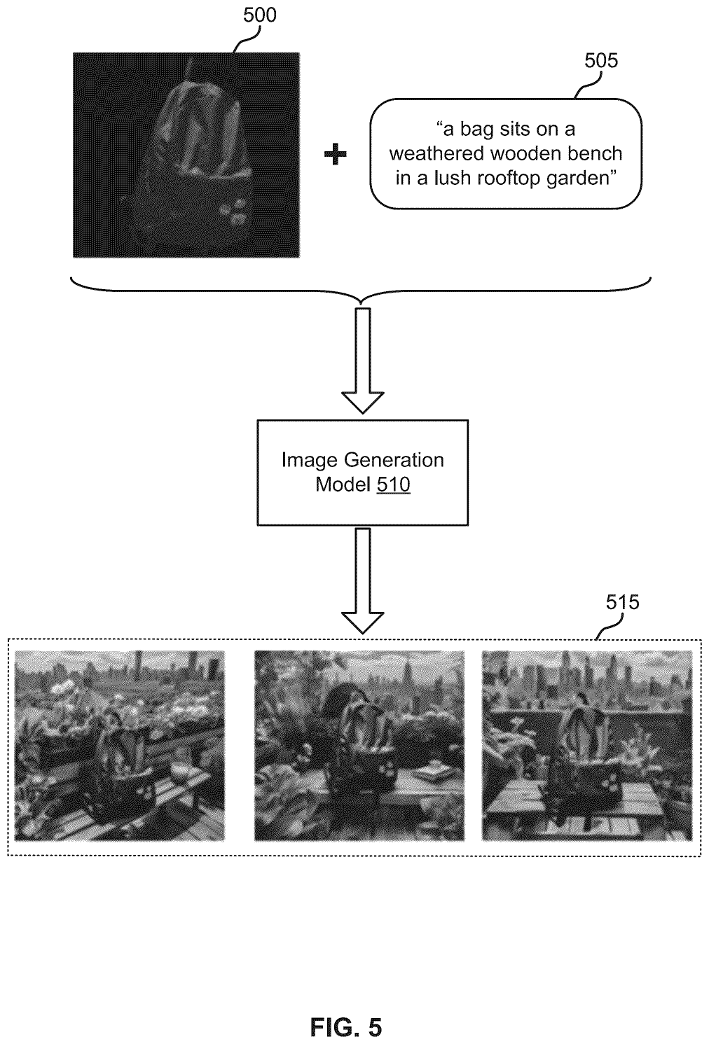

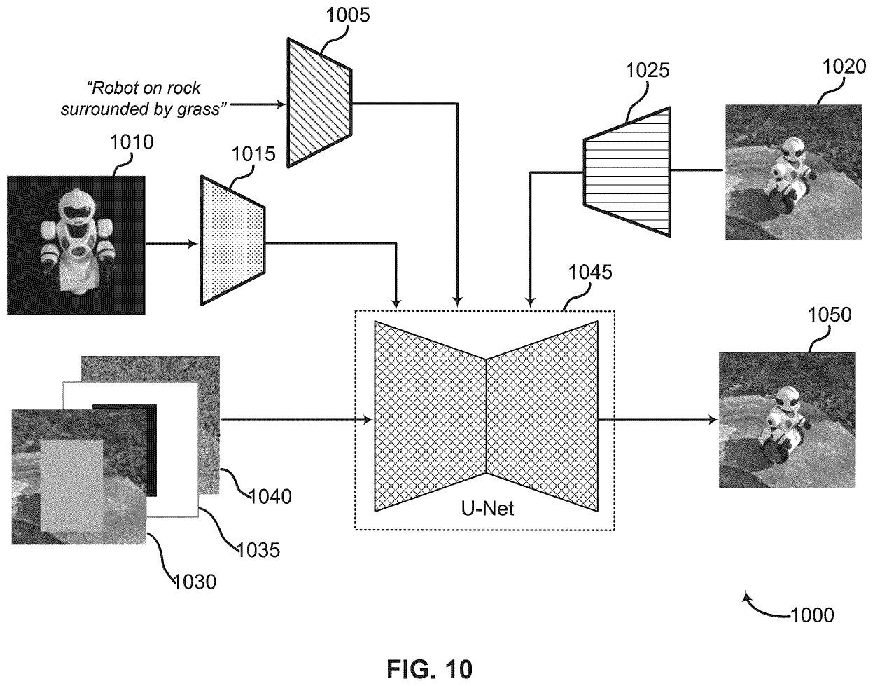

Background image 300 is an example of, or includes aspects of, the corresponding element described with reference to FIGS. 4 and 10. Reference image 305 is an example of, or includes aspects of, the corresponding element described with reference to FIGS. 4-7, 10, 12, and 13. Text prompt 310 is an example of, or includes aspects of, the corresponding element described with reference to FIGS. 5, 11, and 12. Synthetic image 320 is an example of, or includes aspects of, the corresponding element described with reference to FIGS. 4 and 10.

FIG. 4 shows an example of object insertion without text guidance according to aspects of the present disclosure. The example shown includes background image 400, reference image 405, image generation model 410, and synthetic image 415.

In some embodiments, image generation model 410 obtains reference image 405 and background image 400, where reference image 405 depicts a foreground object (e.g., a bag) and the background image 400 depicts a scene (e.g., an outdoor scene having a chair on the ground). In some examples, image generation model 410 generates synthetic image 415 based on reference image 405 and background image 400. The synthetic image 415 depicts the object at a location within the scene.

Referring to FIGS. 3-4 (comparing synthetic image 415 and synthetic image 320 with reference to FIG. 3), synthetic image 415 is generated without a text prompt. Accordingly, unlike synthetic image 320 which depicts a dirt-covered bag corresponding to text prompt 310, synthetic image 415 depicts a bag corresponding to reference image 405 (without text guidance). The bag in synthetic image 415 is not covered in dirt.

Background image 400 is an example of, or includes aspects of, the corresponding element described with reference to FIGS. 3 and 10. Reference image 405 is an example of, or includes aspects of, the corresponding element described with reference to FIGS. 3, 5-7, 10, 12, and 13. Image generation model 410 is an example of, or includes aspects of, the corresponding element described with reference to FIGS. 3, 5, 6, 9, 10, and 13. Synthetic image 415 is an example of, or includes aspects of, the corresponding element described with reference to FIGS. 3 and 10.

FIG. 5 shows an example of text-to-image generation according to aspects of the present disclosure. The example shown includes reference image 500, text prompt 505, image generation model 510, and synthetic images 515.

In some examples, image generation model 510 obtains reference image 500 and text prompt 505 to generate synthetic image 515. Image generation model 510 incorporates aspects of text prompt 505 to depict an object from reference image 500 within a scene as described in text prompt 505. In some examples, image generation model 510 is trained with a combination of channels and text prompts and generates masked regions based on background information provided by text prompt 505. For example, text prompt 505 is “a bag sits on a weathered wooden bench in a lush rooftop garden”. Accordingly, synthetic image 515 depicts a bag (a foreground object) from reference image 500 on a weathered wooden bench in a lush rooftop garden.

In an embodiment, image generation model 510 generates high quality synthetic images which preserve the identity of the object (e.g., the foreground object in reference image 500) while varying the scene and the context of the object guided by text prompt 505. Synthetic images 515 show that the target object (e.g., the bag) has variation (i.e. different poses, views, etc.) while the identity of the object is preserved. Additionally, synthetic images 515 are diverse due to the different variations of scenes.

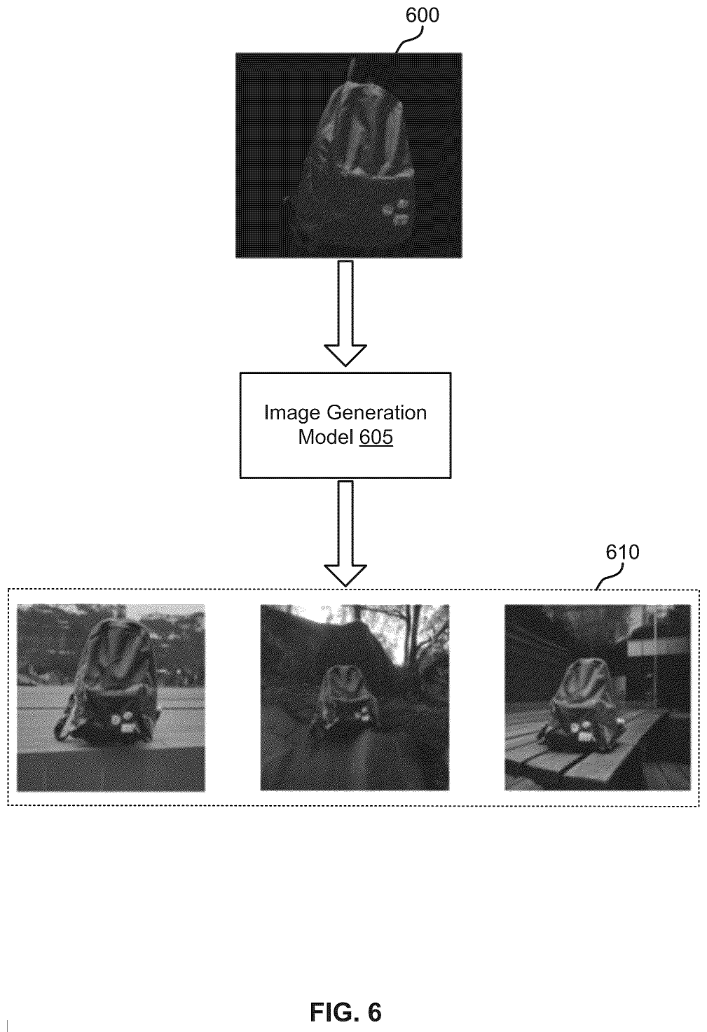

Image generation model 510 is an example of, or includes aspects of, the corresponding element described with reference to FIGS. 3, 4, 6, 9, 10, and 13. Reference image 500 is an example of, or includes aspects of, the corresponding element described with reference to FIGS. 3, 4, 6, 7, 10, 12, and 13. Text prompt 505 is an example of, or includes aspects of, the corresponding element described with reference to FIGS. 3, 11, and 12. Synthetic images 515 is an example of, or includes aspects of, the corresponding element described with reference to FIG. 6.

FIG. 6 shows an example of image generation according to aspects of the present disclosure. The example shown includes reference image 600, image generation model 605, and synthetic images 610.

In an embodiment, image generation model 605 obtains reference image 600 as input, where reference image 600 depicts a foreground object. Image generation model 605 generates synthetic images 610. In contrast to synthetic images shown in FIGS. 3-5, synthetic images 610 are generated without a text prompt and a background image that can guide the generation process (i.e., no text guidance or background information). Image generation model 605, based on its own internal knowledge, generates synthetic images 610 by generating different backgrounds. Additionally, objects in synthetic images 610 have different views, poses, angles, lighting effects, etc. compared to the foreground object in reference image 600. Image generation model 605 is an example of, or includes aspects of, the corresponding element described with reference to FIGS. 3-5, 9, 10, and 13.

Reference image 600 is an example of, or includes aspects of, the corresponding element described with reference to FIGS. 3-5, 7, 10, 12, and 13. Synthetic images 610 is an example of, or includes aspects of, the corresponding element described with reference to FIG. 5.

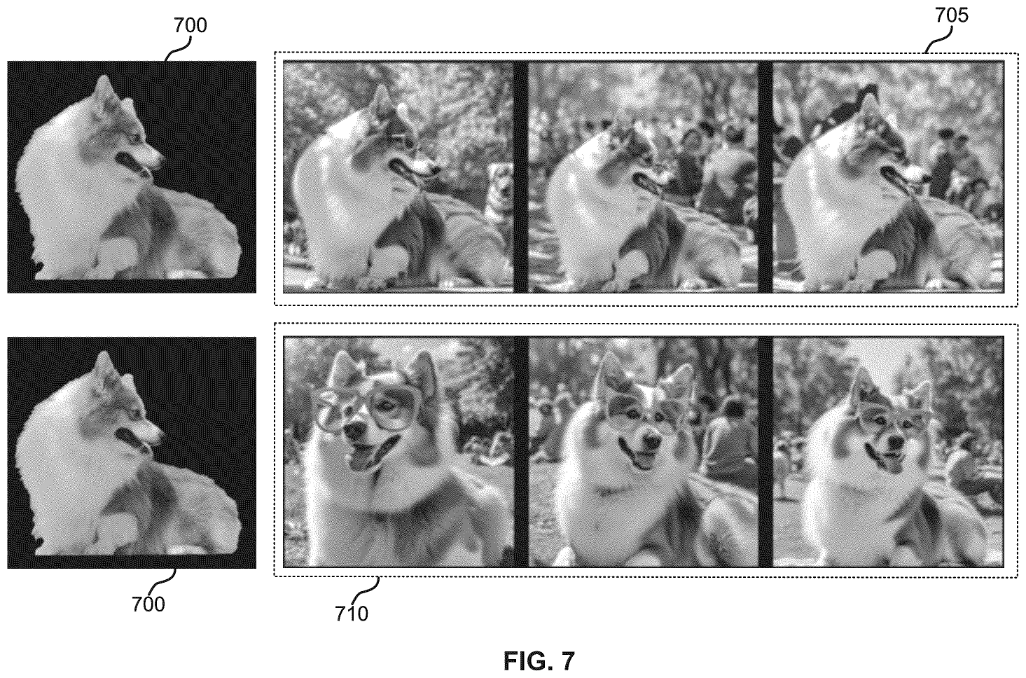

FIG. 7 shows an example of controlling the effect of identity modality according to aspects of the present disclosure. The example shown includes reference image 700, first set of synthesized images 705, and second set of synthesized images 710. Reference image 700 is an example of, or includes aspects of, the corresponding element described with reference to FIGS. 3-6, 10, 12, and 13.

In some embodiments, image generation model 925 as described in FIG. 9 can control the effect of identity modality at inference time. During inference time, image generation model 925 is implemented to control the mode of operation and where conditioning is inserted in the U-Net. The separate cross-attention for text and identity provides a way to balance their influence across each layer. The image generation model 925 mixes the text weight and identity weight at each attention layer to obtain better prompt alignment and content insertion/diversity. The image generation model 925 obtains improved prompt alignment and content insertion/diversity by weighing them based on the order of the attention layer and then adding the modalities. In some examples, when higher weights are assigned to the identity branch cross-attention outputs in the lower layers, the structure and fine-grained identity is better preserved. However, assigning higher weights to the identity branch cross-attention outputs in the lower layers may have an impact on diversity among the images generated and cause the structure of the object to be too rigid. This is because the lower-level layers in U-Net store structural information and so the model is implemented not to hallucinate the object in different poses. This structural rigidness is reduced by setting the identity cross-attention outputs to 0 for the first few low-level layers.

Referring to examples in FIG. 7, the first set of synthesized images 705 include objects (i.e., “dog”) resembling the dog object in reference image 700 (i.e., an identity reference image). The close similarity between objects from the first set of synthesized images 705 and the object from reference image 700 is due to the fact that same weights are set for text and identity for all the layers. In the second set of synthesized images 710, the objects change in pose, size and location because the identity weights in the first 30% of the low-level layers are set to 0.

FIG. 8 shows an example of a method 800 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 805, the system obtains a reference image, a text prompt, and a background image, where the reference image depicts an object, the text prompt describes a target effect for the object, and the background image depicts a scene. In some cases, the operations of this step refer to, or may be performed by, an image generation model as described with reference to FIGS. 3-6, 9, 10, and 13. In some examples, the reference image depicts an object, the text prompt describes a target effect for the object, and the background image depicts a scene.

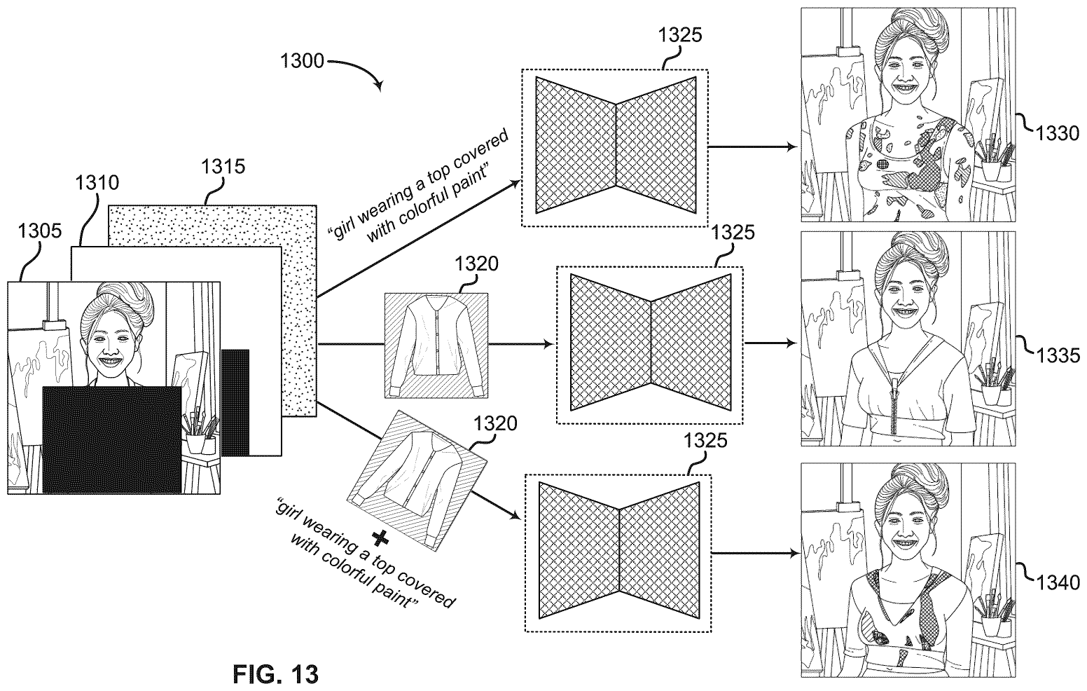

Referring to an example in FIG. 13, image generation model 1300 obtains a reference image and a text prompt as inputs. The reference image depicts a target object or a foreground object (e.g. a blouse worn by women), and the text prompt describes a target effect for the object (e.g., “girl wearing a top covered with colorful paint”). Here, the target effect is to cover the “top” object (i.e., blouse worn by women) that the girl is wearing in colorful paint. Taking the reference image and text prompt as inputs, image generation model 1300 generates a synthetic image depicting the target object (the blouse or the top) with the target effect from the text prompt being applied to the object (e.g., her top is covered in paint).

At operation 810, the system generates a noise input based on the object and the background image, where the noise input indicates a location of the object within the scene. In some cases, the operations of this step refer to, or may be performed by, an image generation model as described with reference to FIGS. 3-6, 9, 10, and 13.

Referring to FIG. 13, masked background image 1305 includes a masked region indicating a location for image generation model 1300 to fill in with generated content. In some cases, the masked region is represented by a solid black bounding box. In this example, the masked region is located on the bottom portion of the object (just below the girl's face) indicating the region where the “top” should appear in the synthesized image. Accordingly, image generation model 1300 synthesizes the image with a top in the masked region (i.e., inpainting) and transforms the object according to the target effect in the text prompt. The masked information is included in or concatenated to the noise map 1315, where the noise map 1315 is denoised using a reverse diffusion process according to aspects of FIG. 16.

In some examples, the system obtains an object mask indicating the location of the object in the scene, where the noise input includes a channel corresponding to the object mask. The image generation model (e.g., a diffusion model), via a reverse diffusion process described with reference to FIGS. 14 and 16, denoises the noise input based on the reference image and the text prompt.

At operation 815, the system generates, using an image generation model, a synthetic image based on the reference image, the text prompt, the background image, and the noise input, where the synthetic image depicts the object at the location within the scene with the target effect applied to the object. In some cases, the operations of this step refer to, or may be performed by, an image generation model as described with reference to FIGS. 3-6, 9, 10, and 13.

In some examples, the text prompt and the background image, alone or in combination, may not be included as inputs for the image generation model. That is, the text prompt and/or the background image are optional. In some examples, the system obtains a single object prompt and a background image, wherein the object prompt describes an object with a target effect and the background prompt describes a scene. The object prompt can be an image of the object, a text description of the object, a nonce token representing the object, or a combination thereof. The background prompt can be a text description or an image depicting the scene, or both. In some cases, the object prompt and the background prompt can be extracted from a single preliminary prompt. A noise input is generated based on the object prompt and the background prompt, where the noise input indicates a location of the object within the scene. The image generation model generates a synthetic image based on the object prompt, the background prompt, and the noise input, where the synthetic image depicts the object at the location within the scene with the target effect applied to the object

Referring to the example in FIG. 13, the diffusion model generates a synthetic image based on the reference image, the text prompt, the background image, and the noise input. The synthetic image depicts the target object in the context of the background scene. The diffusion model fills in the masked region of masked background image with generative content depicting a girl wearing the jacket (having substantial similar style as the jacket from reference image). Additionally, the target effect is applied to the object in the synthetic image (e.g., the girl's top is covered with colorful paint).

In some embodiments, the trained image generation model can perform tasks such as multiple content creation, customization and composition. The image generation model performs content insertion into a background image that harmonizes the content and the model provides text and image conditioned editing and styling. Additionally, the image generation model performs content blending with harmonization control through attention masking and modulation. Object style consistency and control are increased.

In an embodiment, the image generation model includes a pre-trained model trained for text-to-image generation. The image generation model is trained with only text input for a percentage of the training. As such, the image generation model works well with text input.

In an embodiment, the image generation model can fill masked region given text input. The image generation model is trained with a combination of channels and text input, the model can generate masked region given background information with good quality.

In an embodiment, the image generation model can perform custom text-to-image generation. Given an identity reference image and a text prompt, the image generation model generates high quality images with good identity preservation. In some examples, the model is trained with only identity input, the model generates variations of the a target object even though no text is provided.

In an embodiment, the image generation model performs custom object insertion. The image generation model obtains background reference image with location bounding box and places a target object with good harmonization.

In an embodiment, the image generation model performs object insertion with text guidance. When placing the custom object in the bounding box region, the user may want to make changes to the attributes or appearance of the custom object such that it blends well with the scene. In some examples, the image generation model is trained with all modalities when the channels are not dropped, hence the model performs object insertion given text or image as guidance. In an example shown in FIG. 3, the bag blends with the background with improved semantic harmonization as the model adds dirt on the bag following text prompt “Bag covered with dirt”. The model provides users with flexibility to further enhance their creations using their custom objects.

In FIGS. 1-8, a method, apparatus, non-transitory computer readable medium, and system for image generation are described. One or more aspects of the method, apparatus, non-transitory computer readable medium, and system include obtaining a reference image, a text prompt, and a background image, wherein the reference image depicts an object, the text prompt describes a target effect for the object, and the background image depicts a scene; generating a noise input based on the object and the background image, wherein the noise input indicates a location of the object within the scene; and generating, using an image generation model, a synthetic image based on the reference image, the text prompt, the background image, and the noise input, wherein the synthetic image depicts the object at the location within the scene with the target effect applied to the object.

Some examples of the method, apparatus, non-transitory computer readable medium, and system further include obtaining a preliminary image depicting the object. Some examples further include removing a background from the preliminary image to obtain the reference image. Some examples of the method, apparatus, non-transitory computer readable medium, and system further include obtaining an object mask indicating the location of the object in the scene, wherein the noise input includes a channel corresponding to the object mask. Some examples of the method, apparatus, non-transitory computer readable medium, and system further include denoising the noise input based on the reference image and the text prompt.

Some examples of the method, apparatus, non-transitory computer readable medium, and system further include encoding the reference image to obtain an identity embedding, wherein the synthetic image is generated based on the identity embedding. Some examples of the method, apparatus, non-transitory computer readable medium, and system further include encoding the background image to obtain a background embedding, wherein the synthetic image is generated based on the background embedding. Some examples of the method, apparatus, non-transitory computer readable medium, and system further include encoding the text prompt to obtain a text embedding, wherein the synthetic image is generated based on the text embedding. Some examples of the method, apparatus, non-transitory computer readable medium, and system further include obtaining an identity preservation value. Some examples further include combining a first attention weight corresponding to the reference image and a second attention weight corresponding to the text prompt based on the identity preservation value.

### Network Architecture

FIG. 9 shows an example of an image generation apparatus 900 according to aspects of the present disclosure. The example shown includes image generation apparatus 900, processor unit 905, I/O module 910, user interface 915, memory unit 920, image generation model 925, and training component 955. Image generation apparatus 900 is an example of, or includes aspects of, the corresponding element described with reference to FIG. 1.

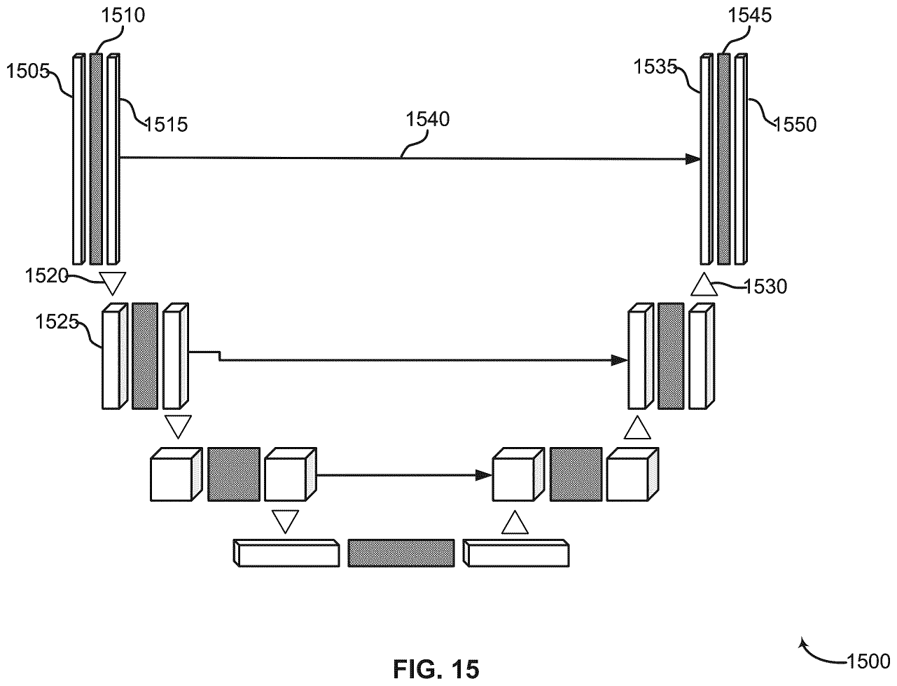

Image generation apparatus 900 may include an example of, or aspects of, the guided diffusion model described with reference to FIG. 14 and the U-Net described with reference to FIG. 15. In some embodiments, image generation apparatus 900 includes processor unit 905, I/O module 910, user interface 915, memory unit 920, image generation model 925, and training component 955. Training component 955 updates parameters of the image generation apparatus 900 stored in memory unit 920. In some examples, the training component 955 is located outside the image generation apparatus 900.

Processor unit 905 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 905 is configured to operate a memory array using a memory controller. In other cases, a memory controller is integrated into processor unit 905. In some cases, processor unit 905 is configured to execute computer-readable instructions stored in memory unit 920 to perform various functions. In some aspects, processor unit 905 includes special purpose components for modem processing, baseband processing, digital signal processing, or transmission processing. According to some aspects, processor unit 905 comprises one or more processors described with reference to FIG. 21.

Memory unit 920 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 905 to perform various functions described herein.

In some cases, memory unit 920 includes a basic input/output system (BIOS) that controls basic hardware or software operations, such as an interaction with peripheral components or devices. In some cases, memory unit 920 includes a memory controller that operates memory cells of memory unit 920. For example, the memory controller may include a row decoder, column decoder, or both. In some cases, memory cells within memory unit 920 store information in the form of a logical state. According to some aspects, memory unit 920 is an example of the memory subsystem 2110 described with reference to FIG. 21.

According to some aspects, image generation apparatus 900 uses one or more processors of processor unit 905 to execute instructions stored in memory unit 920 to perform functions described herein. For example, image generation apparatus 900 may obtain a reference image, a text prompt, and a background image, where the reference image depicts an object, the text prompt describes a target effect for the object, and the background image depicts a scene. Image generation apparatus 900 generates a noise input based on the object and the background image, where the noise input indicates a location of the object within the scene. Image generation apparatus 900 generates, using an image generation model, a synthetic image based on the reference image, the text prompt, the background image, and the noise input. The synthetic image depicts the object at the location within the scene with the target effect applied to the object.

The memory unit 920 may include an image generation model 925 trained to obtain a reference image, a text prompt, and a background image. The reference image depicts an object, the text prompt describes a target effect for the object, and the background image depicts a scene. The image generation model 925 then generates a noise input based on the object and the background image, where the noise input indicates a location of the object within the scene. The image generation model 925 generates a synthetic image based on the reference image, the text prompt, the background image, and the noise input, where the synthetic image depicts the object at the location within the scene with the target effect applied to the object. For example, after training, the image generation model 925 may perform inferencing operations as described with reference to FIGS. 2 and 8.

In some embodiments, the image generation model 925 is an Artificial neural network (ANN) such as the guided diffusion model described with reference to FIG. 14 and the U-Net described with reference to FIG. 15. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 925 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

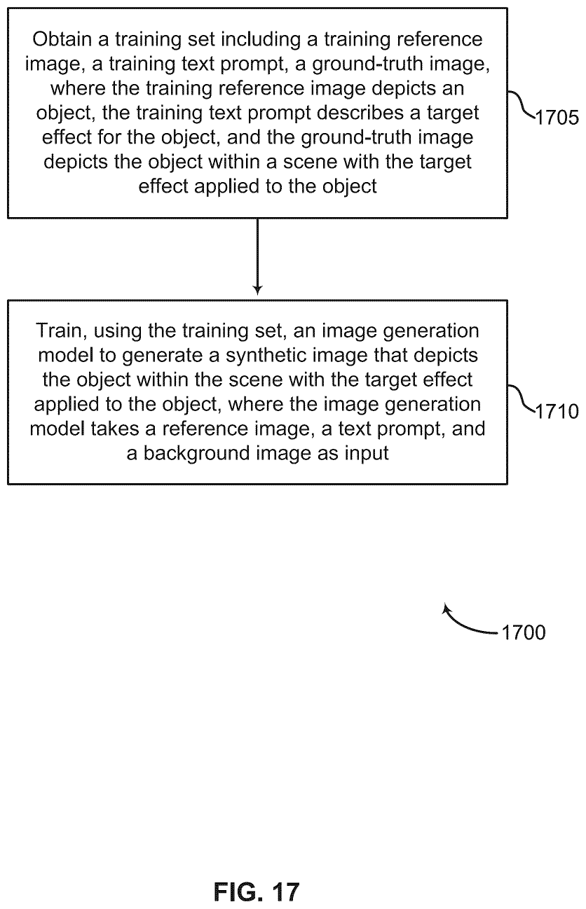

Training component 955 may train the image generation model 925. For example, parameters of the image generation model 925 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 17-20). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 925 can be used to make predictions on new, unseen data (i.e., during inference).

I/O module 910 receives inputs from and transmits outputs of the image generation apparatus 900 to other devices or users. For example, I/O module 910 receives inputs for the image generation model 925 and transmits outputs of the image generation model 925. According to some aspects, I/O module 910 is an example of the I/O interface 2120 described with reference to FIG. 21.

Image generation model 925 is an example of, or includes aspects of, the corresponding element described with reference to FIGS. 3-6, 10, and 13. In one embodiment, image generation model 925 includes identity encoder 930, text encoder 935, image encoder 940, diffusion model 945, and image editing component 950.

Diffusion model 945 is an example of, or includes aspects of, the corresponding element described with reference to FIGS. 10-13. In some examples, image generation model 925 is pre-trained and diffusion model 945 includes a U-Net architecture as described in FIG. 15. In some cases, diffusion model 945 is fined-tuned with mask channels such that training component 955 drops the channels 50% of the time by making the mask channels to 0's.

According to some embodiments, identity encoder 930 encodes the reference image to obtain an identity embedding, where the synthetic image is generated based on the identity embedding. Identity encoder 930 is an example of, or includes aspects of, the corresponding element described with reference to FIG. 10.

According to some embodiments, text encoder 935 encodes the text prompt to obtain a text embedding, where the synthetic image is generated based on the text embedding. Text encoder 935 is an example of, or includes aspects of, the corresponding element described with reference to FIG. 10.

According to some embodiments, image encoder 940 encodes the background image to obtain a background embedding, where the synthetic image is generated based on the background embedding. Image encoder 940 is an example of, or includes aspects of, the corresponding element described with reference to FIG. 10.

According to some embodiments, image editing component 950 obtains a preliminary image depicting the object. In some examples, image editing component 950 removes a background from the preliminary image to obtain the reference image. In some examples, image editing component 950 obtains a preliminary training image depicting the object. Image editing component 950 removes a background from the preliminary training image to obtain the training reference image.

According to some embodiments, training component 955 obtains a training set including a training reference image, a training text prompt, a ground-truth image. The training reference image depicts an object, the training text prompt describes a target effect for the object, and the ground-truth image depicts the object within a scene with the target effect applied to the object. In some examples, training component 955 trains, using the training set, image generation model 925 to generate a synthetic image that depicts the object within the scene with the target effect applied to the object, where the image generation model 925 takes a reference image, a text prompt, and a background image as input.

In some examples, training component 955 identifies a pre-determined dropping ratio. Training component 955 drops the object mask based on the pre-determined dropping ratio by setting values of the object mask to zeros. In some examples, training component 955 generates an intermediate output image. Training component 955 computes a reconstruction loss between the intermediate output image and the ground-truth image. Training component 955 updates parameters of the image generation model 925 based on the reconstruction loss. In some examples, training component 955 jointly trains image generation model 925, identity encoder 930, text encoder 935, and image encoder 940.

FIG. 10 shows an example of an image generation model 1000 according to aspects of the present disclosure. The example shown includes image generation model 1000, text encoder 1005, reference image 1010, identity encoder 1015, background image 1020, image encoder 1025, masked background image 1030, object mask 1035, noise map 1040, diffusion model 1045, and synthetic image 1050. Image generation model 1000 is an example of, or includes aspects of, the corresponding element described with reference to FIGS. 3-6, 9, and 13.

In an embodiment, image generation model 1000 includes text encoder 1005, identity encoder 1015, image encoder 1025, and diffusion model 1045. In some examples, identity encoder 1015 includes a DINO encoder which is a self-supervised model that generates structural representation based on reference image 1010. These embeddings represent the fine-grained structure of an object in the reference image 1010 along with color and texture information. Identity encoder 1015 focuses on the object (e.g., “hero” object) and image generation model 1000 masks out the background of reference image 1010. The foreground object (e.g., hero object) is input to the identity encoder 1015. The identity encoder 1015 generates an embedding of shape 257×1536. One of the embeddings in the 257 dimensions provides the global structure information of reference image 1010. The identity encoder 1015 captures the identity of the object in reference image 1010. Identity encoder 1015 is an example of, or includes aspects of, the corresponding element described with reference to FIG. 9.

In some examples, text encoder 1005 includes a T5 encoder which is used to extract a text embedding based on a text prompt. In some cases, text encoder 1005 includes a text CLIP encoder (instead of T5 encoder). Text encoder 1005 may include any other encoders that can convert text into a vector representation. Referring to an example in FIG. 10, the text prompt is “Robot on rock surrounded by grass” that describes a scene in background image 1020. Text encoder 1005 is an example of, or includes aspects of, the corresponding element described with reference to FIG. 9.

Reference image 1010 is an example of, or includes aspects of, the corresponding element described with reference to FIGS. 3-7, 12, and 13. Background image 1020 is an example of, or includes aspects of, the corresponding element described with reference to FIGS. 3 and 4.

In some examples, image encoder 1025 takes background image 1020 as input. Image encoder 1025 encodes background image 1020 to obtain image semantic information represented by a 1×1024 vector. In some examples, image encoder 1025 includes a CLIP image encoder. However, image encoder 1025 is not limited to a particular type of encoders and image encoder 1025 extracts image embeddings from background image 1020. In some cases, image encoder 1025 is optional. Image encoder 1025 can add high-level image similarity reference during inference time. In some cases, image encoder 1025 is optional and can be removed from image generation model 1000.

During training, input to image encoder 1025 (i.e., a background image) may be dropped based on a pre-determined dropping ratio such that the image generation model 1000 focuses on learning the text input and the identity input. In some examples, the object mask 1035 is dropped based on a pre-determined dropping ratio by setting values of the object mask 1035 to zeros. Additionally or alternatively, masked background image 1030 is dropped based on a pre-determined dropping ratio by setting values of masked background image 1030 to zeros. Image encoder 1025 is an example of, or includes aspects of, the corresponding element described with reference to FIG. 9.

In some embodiments, mask channels are used (as input to diffusion model 1045) to generate content keeping an object consistent or to insert an object harmoniously into a scene and adapt to the context of the scene. Image generation model 1000 identifies four additional channels that are concatenated to the latent code. In some examples, one mask channel (i.e., corresponding to object mask 1035) is used to signify where the foreground object is. Three masked-image channels (corresponding to masked background image 1030) provide information about where the object needs to be inserted within the context of the input images. The mask in masked background image 1030 may include a bounding box or other shape that is tighter to the object boundaries. To indicate the location where the object needs to be placed, the region tokens are converted to 0 values.

In some examples, noise map 1040 is initiated based on a distribution and noise map 1040 is input to diffusion model 1045. Diffusion model 1045 removes noise based on noise map 1040 during a reverse diffusion process. Noise map 1040 is an example of, or includes aspects of, the corresponding element described with reference to FIG. 16.

During inference time, diffusion model 1045 denoises the latent code such that the original tokens of the background are copied back and diffusion model 1045 mainly denoises the masked region while keeping the background information as context.

In some examples, diffusion model 1045 includes a diffusion U-Net architecture as described in FIG. 15. Diffusion model 1045 is conditioned to model the distribution P (I|X, Y), where/denotes the 128×128 RGB image, X∈R¹⁰²⁴ is a ground-truth image clip embedding and Y∈R^{128×1024} is text embedding (e.g., T5 text embedding). Diffusion model 1045 is trained with this setting for millions of iterations. Once diffusion model 1045 has learned to generate images given either text or image as conditions to the model, the pre-trained model is then fine-tuned (e.g., use the checkpoint as a base checkpoint for finetuning). Diffusion model 1045 can perform localized editing since diffusion model 1045 is configured to obtain different input modalities. Embodiments of the present disclosure are not limited to diffusion U-Net models and other diffusion-based or similar generative models may be used to replace U-Net. Diffusion model 1045 is an example of, or includes aspects of, the corresponding element described with reference to FIGS. 9, and 11-13.

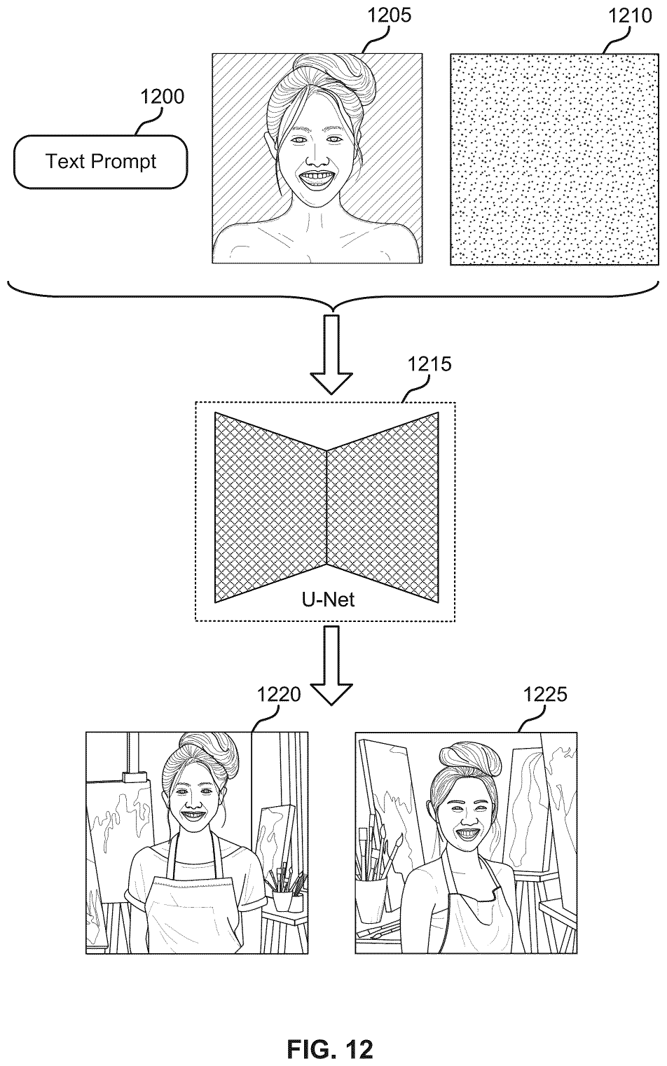

Masked background image 1030 is an example of, or includes aspects of, the corresponding element described with reference to FIG. 13. Object mask 1035 is an example of, or includes aspects of, the corresponding element described with reference to FIG. 13. Noise map 1040 is an example of, or includes aspects of, the corresponding element described with reference to FIGS. 12 and 13. Synthetic image 1050 is an example of, or includes aspects of, the corresponding element described with reference to FIGS. 3 and 4.

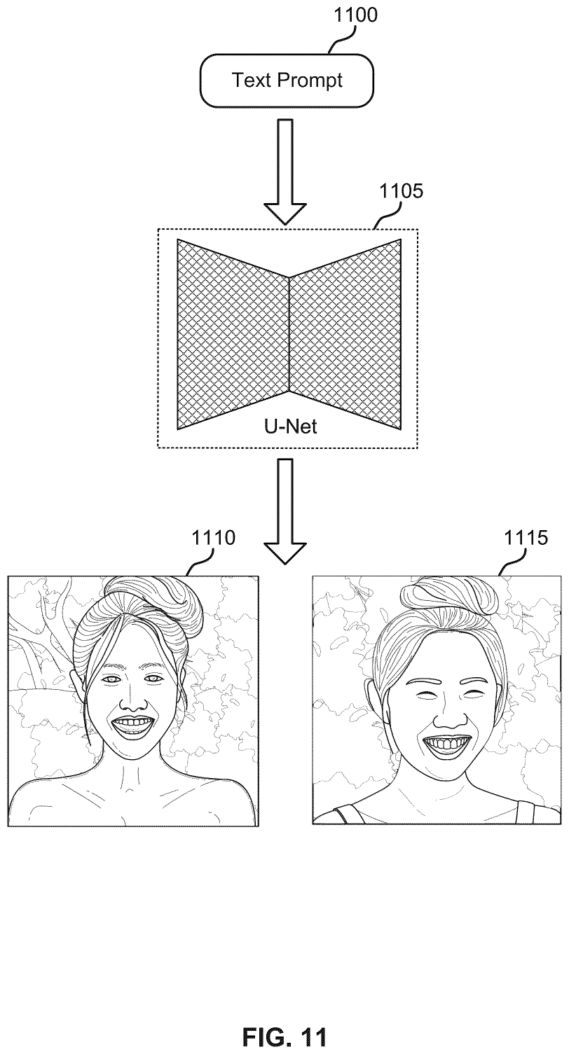

FIG. 11 shows an example of an image generation model according to aspects of the present disclosure. The example shown includes text prompt 1100, diffusion model 1105, first preliminary image 1110, and second preliminary image 1115.

In some examples, text prompt 1100 is input to diffusion model 1105 (e.g., a U-Net) to generate images corresponding to the text prompt 1100 (e.g., first preliminary image 1110 and second preliminary image 1115 are output images). An example of text prompt 1100 is “closeup portrait photo of a young Chinese woman's full face, giggling, hair in a messy bun, symmetry, playful shadows, in a garden”. Diffusion model 1105 includes a U-Net architecture as described with reference to FIG. 15.

Text prompt 1100 is an example of, or includes aspects of, the corresponding element described with reference to FIGS. 3, 5, and 12. Diffusion model 1105 is an example of, or includes aspects of, the corresponding element described with reference to FIGS. 9, 10, 12, and 13.

FIG. 12 shows an example of an image generation model according to aspects of the present disclosure. The example shown includes text prompt 1200, reference image 1205, noise map 1210, diffusion model 1215, first output image 1220, and second output image 1225.

In some examples, diffusion model 1215 obtains text prompt 1200, reference image 1205, and noise map 1210 as inputs. The reference image 1205 depicts an object while the text prompt 1200 describes a target effect for the object. In some examples, diffusion model 1215 generates the first output image 1220 and second output image 1225 based on text prompt 1200, reference image 1205, and noise map 1210. The first output image 1220 and the second output image 1225 preserve object identity as in reference image 1205 within a scene consistent with elements from text prompt 1200. In some examples, noise map 1210 is converted into an output image using a reverse diffusion process described with reference to FIG. 16.

For example, text prompt 1200 is “a person wears casual clothes, consisting of jeans and a soft t-shirt, clad in a paint-splattered smock, stands before an easel in a cluttered studio, the early morning light streaming through a large window”. Reference image 1205 is the same as the first preliminary image 1110 with reference to FIG. 11. Diffusion model 1215 denoises noise map 1210 guided by text prompt 1200 and reference image 1205. Diffusion model 1215 generates first output image 1220 and second output image 1225 depicting the woman from reference image 1205 within a scene consistent with text prompt 1200. In some examples, the first output image 1220 and the second output image 1225 include objects that vary from the target object from reference image 1205 in terms of pose, viewpoint, angle, lighting effect, etc. The identity of the target object is preserved. Diffusion model 1215 is an example of, or includes aspects of, the corresponding element described with reference to FIGS. 9-11, and 13.

Text prompt 1200 is an example of, or includes aspects of, the corresponding element described with reference to FIGS. 3, 5, and 11. Reference image 1205 is an example of, or includes aspects of, the corresponding element described with reference to FIGS. 3-7, 10, and 13. Noise map 1210 is an example of, or includes aspects of, the corresponding element described with reference to FIGS. 10 and 13.

FIG. 13 shows an example of an image generation model 1300 according to aspects of the present disclosure. The example shown includes image generation model 1300, masked background image 1305, object mask 1310, noise map 1315, reference image 1320, diffusion model 1325, first synthetic image 1330, second synthetic image 1335, and third synthetic image 1340. Image generation model 1300 is an example of, or includes aspects of, the corresponding element described with reference to FIGS. 3-6, 9, and 10. Diffusion model 1325 is an example of, or includes aspects of, the corresponding element described with reference to FIGS. 9-12.

According to some embodiments, image generation model 1300 obtains a masked background image 1305, an object mask 1310, and a noise map 1315 as input to diffusion model 1325. The masked background image 1305 depicts a background scene to be maintained throughout the image generation process and a masked region to fill in with generated content. The object mask 1310 indicates the location of a target object within the scene. The noise map 1315 is to be denoised using a reverse diffusion process described in FIGS. 14 and 16.

In some examples, masked background image 1305 corresponds to the first output image 1220 with reference to FIG. 12. In some examples, image generation model 1300 obtains a text prompt (describing a target effect for an object), a reference image 1320 (i.e., an identity input), or a combination of the text prompt and reference image 1320. In some examples, diffusion model 1325 includes a U-Net described with reference to FIG. 15.

In an embodiment, image generation model 1300 obtains a text prompt which describes a target effect for the object. Accordingly, diffusion model 1325 generates a first synthetic image 1330 which depicts the object in the context of the background scene based on the text prompt. Here, as an example, the text prompt is “girl wearing a top covered with colorful paint”, and diffusion model 1325 fills in the masked region of masked background image 1305 to generate a synthetic image. The first synthetic image 1330 depicts the girl wearing a top covered in paint within the scene as shown in masked background image 1305.

In some examples, image generation model 1300 obtains reference image 1320 which depicts an object (a foreground object or a target object). Diffusion model 1325 generates a second synthetic image 1335 based on reference image 1320, i.e., an identity input. The second synthetic image 1335 depicts the object from reference image 1320 in the context of the background scene. For example, the reference image 1320 includes a foreground object (a jacket) and diffusion model 1325 fills in the masked region of masked background image 1305 with generative content depicting a girl wearing the jacket (having substantial similar style as the jacket from reference image 1320).

In some examples, image generation model 1300 obtains reference image 1320 and a text prompt as inputs. The reference image 1320 depicts a target object (or a foreground object) and the text prompt describes a target effect for the object (e.g., “girl wearing a top covered with colorful paint”). Here, the target effect is to cover colorful paint for the “top” object that the girl is wearing. Diffusion model 1325 generates a third synthetic image 1340 based on the reference image 1320 and the text prompt. The third synthetic image 1340 depicts the object in the context of the background scene. The diffusion model 1325 fills in the masked region of masked background image 1305 with generative content depicting a girl wearing the jacket (having substantial similar style as the jacket from reference image 1320). Additionally, the target effect is applied to the object in the synthetic image (e.g., the girl's top is covered with colorful paint).

In some embodiments, a unified model is used for content customization and composition (using a single model checkpoint). Referring to FIGS. 12-13, a user begins with a single prompt. For all the different tasks described in FIGS. 12-13, the same model is used. With regard to reference image generation from text, the user creates an asset/custom object it can use as reference for further edits. This is done by providing a text prompt describing the asset to the unified model. As this is global image generation, the channels are dropped. From the images generated from multiple seeds, the user selects the one they like.

The unified model is used to generate variations of the reference image. Now the user has their custom object and can create variations based on a theme that they have in mind. For example, if the user wants to create a scene where the custom object (e.g., a woman with pony is painting and is surrounded by painting equipment), they can provide the text prompt with that description along with the reference image of the custom object. In the backend, a foreground segmentation model removes the background. The foreground mask (as the identity input) is fed to the unified model. The mask channels are dropped. The unified model generates variations based on the foreground mask.

With regard to localized customization, the user selects the image they like and they can perform further edits to different segments of the images by creating a bounding box around the region and providing instructions on how to edit. The instructions are in the form of a text prompt, another custom object that the user already poses or is generated by the unified model, or both. The user can make localized edits. In the third synthetic image 1340, along with the top of the woman being changed to the custom top the user provided, the top blends well with the background as paint is added to it using text as guidance.

Masked background image 1305 is an example of, or includes aspects of, the corresponding element described with reference to FIG. 10. Object mask 1310 is an example of, or includes aspects of, the corresponding element described with reference to FIG. 10. Noise map 1315 is an example of, or includes aspects of, the corresponding element described with reference to FIGS. 10 and 12. Reference image 1320 is an example of, or includes aspects of, the corresponding element described with reference to FIGS. 3-7, 10, and 12.

FIG. 14 shows an example of a guided latent diffusion model 1400 according to aspects of the present disclosure. The guided latent diffusion model 1400 depicted in FIG. 14 is an example of, or includes aspects of, the corresponding element (i.e., diffusion model 945) described with reference to FIG. 9.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 1400 may take an original image 1405 in a pixel space 1410 as input and apply and image encoder 1415 to convert original image 1405 into original image features 1420 in a latent space 1425. Then, a forward diffusion process 1430 gradually adds noise to the original image features 1420 to obtain noisy features 1435 (also in latent space 1425) at various noise levels.

Next, a reverse diffusion process 1440 (e.g., a U-Net ANN) gradually removes the noise from the noisy features 1435 at the various noise levels to obtain denoised image features 1445 in latent space 1425. In some examples, the denoised image features 1445 are compared to the original image features 1420 at each of the various noise levels, and parameters of the reverse diffusion process 1440 of the diffusion model are updated based on the comparison. Finally, an image decoder 1450 decodes the denoised image features 1445 to obtain an output image 1455 in pixel space 1410. In some cases, an output image 1455 is created at each of the various noise levels. The output image 1455 can be compared to the original image 1405 to train the reverse diffusion process 1440.

In some cases, image encoder 1415 and image decoder 1450 are pre-trained prior to training the reverse diffusion process 1440. In some examples, image encoder 1415 and image decoder 1450 are trained jointly, or the image encoder 1415 and image decoder 1450 and fine-tuned jointly with the reverse diffusion process 1440.

The reverse diffusion process 1440 can also be guided based on a text prompt 1460, or another guidance prompt, such as an image, a layout, a segmentation map, etc. The text prompt 1460 can be encoded using a text encoder 1465 (e.g., a multimodal encoder) to obtain guidance features 1470 in guidance space 1475. The guidance features 1470 can be combined with the noisy features 1435 at one or more layers of the reverse diffusion process 1440 to ensure that the output image 1455 includes content described by the text prompt 1460. For example, guidance features 1470 can be combined with the noisy features 1435 using a cross-attention block within the reverse diffusion process 1440.

FIG. 15 shows an example of a U-Net 1500 architecture according to aspects of the present disclosure. In some examples, U-Net 1500 is an example of the component that performs the reverse diffusion process 1440 of guided latent diffusion model 1400 described with reference to FIG. 14 and includes architectural elements of the diffusion model 945 described with reference to FIG. 9. The U-Net 1500 depicted in FIG. 15 is an example of, or includes aspects of, the architecture used within the reverse diffusion process described with reference to FIG. 14.

In some examples, diffusion models are based on a neural network architecture known as a U-Net. The U-Net 1500 takes input features 1505 having an initial resolution and an initial number of channels and processes the input features 1505 using an initial neural network layer 1510 (e.g., a convolutional network layer) to produce intermediate features 1515. The intermediate features 1515 are then down-sampled using a down-sampling layer 1520 such that down-sampled features 1525 have a resolution less than the initial resolution and a number of channels greater than the initial number of channels.

This process is repeated multiple times, and then the process is reversed. That is, the down-sampled features 1525 are up-sampled using up-sampling process 1530 to obtain up-sampled features 1535. The up-sampled features 1535 can be combined with intermediate features 1515 having the same resolution and number of channels via a skip connection 1540. These inputs are processed using a final neural network layer 1545 to produce output features 1550. In some cases, the output features 1550 have the same resolution as the initial resolution and the same number of channels as the initial number of channels.

In some cases, U-Net 1500 takes additional input features to produce conditionally generated output. For example, the additional input features could include a vector representation of an object prompt. The additional input features can be combined with the intermediate features 1515 within the neural network at one or more layers. For example, a cross-attention module can be used to combine the additional input features and the intermediate features 1515.

FIG. 16 shows an example of a diffusion process 1600 according to aspects of the present disclosure. In some examples, diffusion process 1600 describes an operation of the diffusion model 945 described with reference to FIG. 9, such as the reverse diffusion process 1440 of guided latent diffusion model 1400 described with reference to FIG. 14.

As described above with reference to FIG. 14, using a diffusion model can involve both a forward diffusion process 1605 for adding noise to a media item (or features in a latent space) and a reverse diffusion process 1610 for denoising the media item (or features) to obtain a denoised media item. The forward diffusion process 1605 can be represented as q(xₜ|xₜ₋₁), and the reverse diffusion process 1610 can be represented as p(xₜ₋₁|xₜ). In some cases, the forward diffusion process 1605 is used during training to generate media items with successively greater noise, and a neural network is trained to perform the reverse diffusion process 1610 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x₇ have the same dimensionality as x₀.

The neural network may be trained to perform the reverse process. During the reverse diffusion process 1610, the model begins with noisy data x_{T}, such as a noisy media item 1615 and denoises the data to obtain the p (xₜ₋₁|xₜ). At each step t−1, the reverse diffusion process 1610 takes xₜ, such as first intermediate media item 1620, and t as input. Here, t represents a step in the sequence of transitions associated with different noise levels, The reverse diffusion process 1610 outputs xₜ₋₁, such as second intermediate media item 1625 iteratively until x_{T} reverts back to x₀, the original media item 1630. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x)=N(x_{T};0,I) is the pure noise distribution as the reverse process takes the outcome of the forward process, a sample of pure noise, as input and Πₜ₌₁^{T}p_{θ}(xₜ₋₁|xₜ) represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

In FIGS. 9-16, an apparatus, system, and method for image generation are described. One or more aspects of the apparatus, system, and method include at least one processor; at least one memory including instructions executable by the at least one processor; and an image generation model comprising parameters stored in the at least one memory and trained to generate a noise input based on a reference image and a background image, wherein the noise input indicates a location of an object from the reference image within a scene from the background image, and to generate a synthetic image based on the reference image, a text prompt, the background image, and the noise input, wherein the synthetic image depicts the object at the location within the scene with a target effect from the text prompt applied to the object.

Some examples of the apparatus, system, and method further include an identity encoder configured to encode the reference image to obtain an identity embedding, wherein the synthetic image is generated based on the identity embedding.

Some examples of the apparatus, system, and method further include a text encoder configured to encode the text prompt to obtain a text embedding, wherein the synthetic image is generated based on the text embedding.

Some examples of the apparatus, system, and method further include an image encoder configured to encode the background image to obtain a background embedding, wherein the synthetic image is generated based on the background embedding. In some examples, the image generation model comprises a diffusion model.

### Training and Evaluation

FIG. 17 shows an example of a method 1700 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1705, the system obtains a training set including a training reference image, a training text prompt, a ground-truth image, where the training reference image depicts an object, the training text prompt describes a target effect for the object, and the ground-truth image depicts the object within a scene with the target effect applied to the object. In some cases, the operations of this step refer to, or may be performed by, a training component as described with reference to FIG. 9.

In some examples, a conditional generative model (e.g., a diffusion-based model) is initialized using random values. In other examples, the conditional generative model is initialized based on a pre-trained model. In some examples, the conditional generative model includes base parameters from a pre-trained model.

At operation 1710, the system trains, using the training set, an image generation model to generate a synthetic image that depicts the object within the scene with the target effect applied to the object, where the image generation model takes a reference image, a text prompt, and a background image as input. In some cases, the operations of this step refer to, or may be performed by, a training component as described with reference to FIG. 9.

In some embodiments, the synthetic image generated at operation 1710 is compared to the ground-truth image at operation 1705. The difference between the synthetic image and the ground-truth image is measured and parameters of the image generation model are updated.

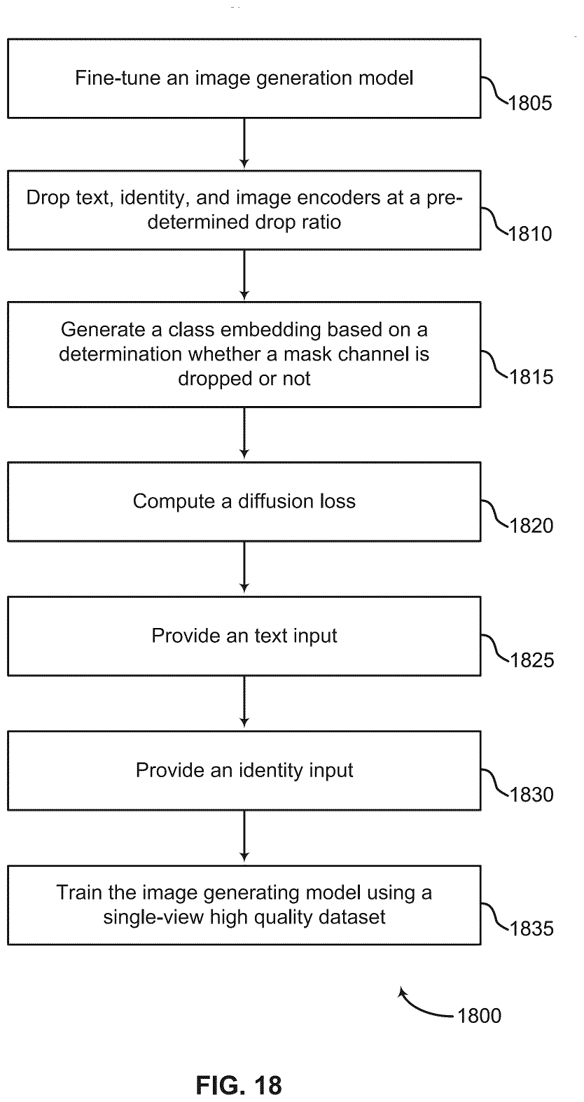

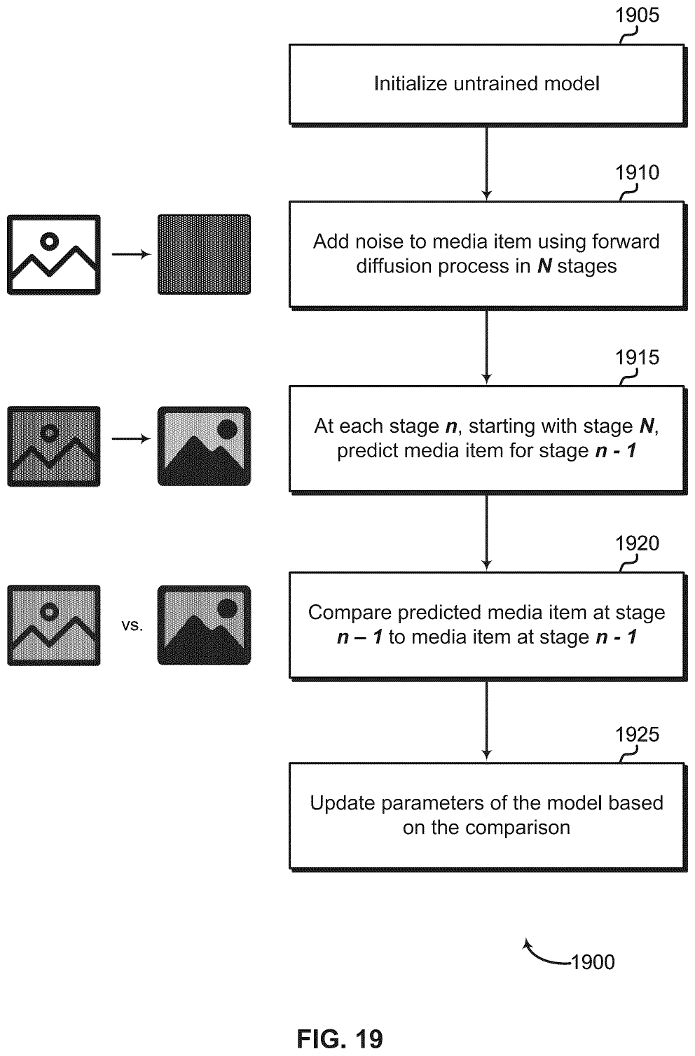

Detail about operation 1710 is further described as a step-by-step procedure with reference to FIG. 18. Detail about training a diffusion model is further described with reference to FIG. 19.

FIG. 18 shows an example of a method 1800 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1805, the system fine-tunes an image generation model. In some cases, the operations of this step refer to, or may be performed by, a training component as described with reference to FIG. 9. In an embodiment, a pre-trained text-to-image generation model is fine-tuned with mask channels, such that the training component drops the channels 50% of the time by setting the mask channels to O's.

At operation 1810, the system drops text, identity, and image encoders at a pre-determined drop ratio. In some cases, the operations of this step refer to, or may be performed by, a training component as described with reference to FIG. 9. In some cases, the training component drops text, identity and image branches with pre-determined drop probabilities, so that image generation model 925 (described with reference to FIG. 9) learns to generate images based on any combination provided during inference time (e.g., a text prompt, a reference/identity image, a background image, or any combination thereof, fed to image generation model 925).

At operation 1815, the system generates a class embedding based on a determination of whether a mask channel is dropped or not. In some cases, the operations of this step refer to, or may be performed by, a training component as described with reference to FIG. 9. In some examples, a class embedding is provided and the class embedding is used to indicate if the mask channel is dropped or not. If the masks are dropped, the training component sets the class embedding to 0. If the masks are not dropped, the training component sets the class embedding to 1. This tunes the image generation model 925 to improve performance for tasks when its class type is activated. The class embedding is added to the positional timestep embedding which is input to a diffusion U-Net.

At operation 1820, the system computes a diffusion loss. In some cases, the operations of this step refer to, or may be performed by, a training component as described with reference to FIG. 9. In some examples, the diffusion loss is calculated by constraining the loss to the generation inside a masked bounding box. When the mask channels are dropped (i.e., the bounding box is the entire image), the diffusion loss is calculated on the entire image.

At operation 1825, the system provides a text input. In some cases, the operations of this step refer to, or may be performed by, a user as described with reference to FIG. 1. The text input (e.g., a text prompt) is fed to image generation model 925 and the text input is confined to the information seen inside the mask (e.g., inside a bounding box).

At operation 1830, the system provides an identity input. In some cases, the operations of this step refer to, or may be performed by, a user as described with reference to FIG. 1. During training, for a significant percentage of the time, image generation model 925 takes identity input (with and without text tokens inside the cross-attention block) while the mask channels are also provided. This enables image generation model 925 to learn text and identity for tasks such as global and local generations and edits.

At operation 1835, the system trains the image generation model using a single-view high quality dataset. In some cases, the operations of this step refer to, or may be performed by, a training component as described with reference to FIG. 9. In some cases, the aesthetic quality of synthetic images generated by the model depends on training text prompts that the U-Net is trained on. During training, the training component exclusively uses a single-view high quality dataset when not dropping the text input to train the diffusion U-Net. A ground-truth image related to the text input may or may not have a main object in the ground-truth image. When an identity image is provided, the paired data is used to train the U-Net.

FIG. 19 shows an example of a method 1900 for training a diffusion model according to aspects of the present disclosure. In some embodiments, the method 1900 describes an operation of the training component 955 described for configuring the image generation model 925 as described with reference to FIG. 9. The method 1900 represents an example for training a reverse diffusion process as described above with reference to FIGS. 14 and 16. In some examples, these operations are performed by a system including a processor executing a set of codes to control functional elements of an apparatus, such as the guided latent diffusion model described in FIG. 14.

Additionally or alternatively, certain processes of method 1900 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1905, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1910, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1915, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1920, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1925, the system updates parameters of the model based on the comparison. For example, parameters of a U-Net may be updated using gradient descent. Time-dependent parameters of the Gaussian transitions can also be learned.

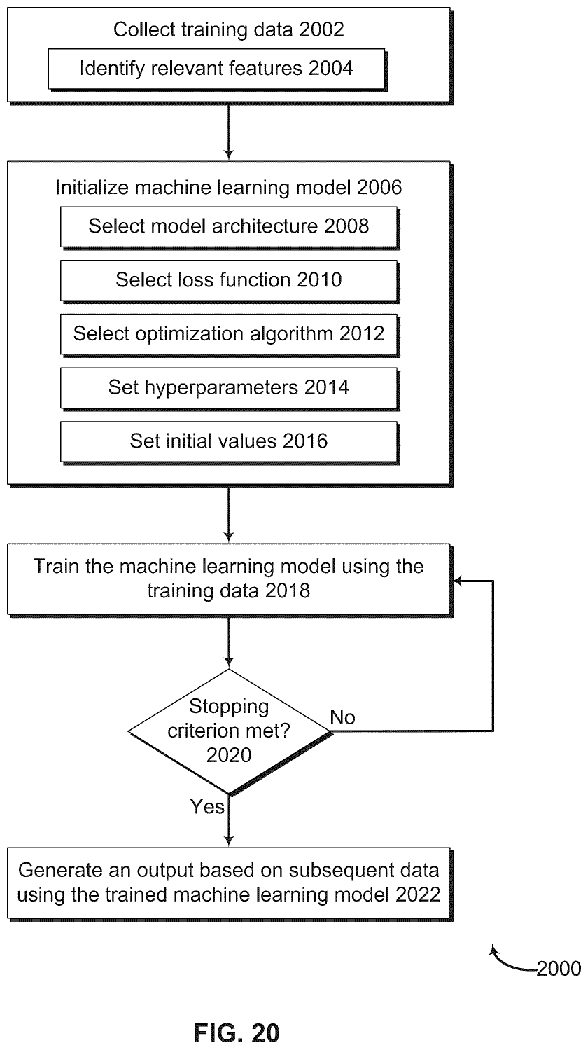

FIG. 20 shows an example of a step-by-step procedure for training a machine learning model according to aspects of the present disclosure. FIG. 20 shows a flow diagram depicting an algorithm as a step-by-step procedure 2000 in an example implementation of operations performable for training a machine-learning model. In some embodiments, the procedure 2000 describes an operation of the training component 955 described for configuring the image generation model 925 as described with reference to FIG. 9. The procedure 2000 provides one or more examples of generating training data, use of the training data to train a machine-learning model, and use of the trained machine-learning model to perform a task.

To begin in this example, a machine-learning system collects training data (block 2002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 2004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 2006). Initialization of the machine-learning model includes selecting a model architecture (block 2008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 2010). The loss function is utilized to measure a difference between an output of the machine-learning model (i.e., predictions) and target values (e.g., as expressed by the training data) to be used to train the machine-learning model. Additionally, an optimization algorithm is selected (2012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 2014) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 2018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 2020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 2020), the procedure 2000 continues training of the machine-learning model using the training data (block 2018) in this example.

If the stopping criterion is met (“yes” from decision block 2020), the trained machine-learning model is then utilized to generate an output based on subsequent data (block 2022). The trained machine-learning model, for instance, is trained to perform a task as described above and therefore once trained is configured to perform that task based on subsequent data received as an input and processed by the machine-learning model.

In FIGS. 17-20, a method, apparatus, non-transitory computer readable medium, and system for image generation are described. One or more aspects of the method, apparatus, non-transitory computer readable medium, and system include obtaining a training set including a training reference image and a training text prompt, wherein the training reference image depicts an object and the training text prompt describes a target effect for the object; generating a noise input based on the training reference image and the training text prompt, wherein the noise input indicates a location of the object; and training, using the training set, an image generation model to generate a synthetic image based on the noise input, wherein the synthetic image depicts the object at the location with the target effect applied to the object

In some embodiments, aspects of the method, apparatus, non-transitory computer readable medium, and system include obtaining a training set including a training reference image, a training text prompt, a ground-truth image, wherein the training reference image depicts an object, the training text prompt describes a target effect for the object, and the ground-truth image depicts the object within a scene with the target effect applied to the object and training, using the training set, an image generation model to generate a synthetic image that depicts the object within the scene with the target effect applied to the object, wherein the image generation model takes a reference image, a text prompt, and a background image as input.

Some examples of the method, apparatus, non-transitory computer readable medium, and system further include obtaining a preliminary image depicting the object. Some examples further include removing a background from the preliminary image to obtain the training reference image. Some examples of the method, apparatus, non-transitory computer readable medium, and system further include generating a noise input based on the object and the ground-truth image, wherein the noise input indicates a location of the object within the scene. Some examples of the method, apparatus, non-transitory computer readable medium, and system further include obtaining an object mask indicating the location of the object in the scene, wherein the noise input includes a channel corresponding to the object mask.

Some examples of the method, apparatus, non-transitory computer readable medium, and system further include identifying a pre-determined dropping ratio. Some examples further include dropping the object mask based on the pre-determined dropping ratio by setting values of the object mask to zeros. Some examples of the method, apparatus, non-transitory computer readable medium, and system further include generating an intermediate output image. Some examples further include computing a reconstruction loss between the intermediate output image and the ground-truth image. Some examples further include updating parameters of the image generation model based on the reconstruction loss.

Some examples of the method, apparatus, non-transitory computer readable medium, and system further include jointly training the image generation model, an identity encoder, a text encoder, and an image encoder.

FIG. 21 shows an example of a computing device 2100 for image generation according to aspects of the present disclosure. The computing device 2100 may be an example of the image generation apparatus 900 described with reference to FIG. 9. In one aspect, computing device 2100 includes processor(s) 2105, memory subsystem 2110, communication interface 2115, I/O interface 2120, user interface component(s) 2125, and channel 2130.

In some embodiments, computing device 2100 is an example of, or includes aspects of, the image generation model of FIG. 9. In some embodiments, computing device 2100 includes one or more processors 2105 that can execute instructions stored in memory subsystem 2110 to perform media generation.

According to some aspects, computing device 2100 includes one or more processors 2105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 2110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2115 operates at a boundary between communicating entities (such as computing device 2100, one or more user devices, a cloud, and one or more databases) and channel 2130 and can record and process communications. In some cases, communication interface 2115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2120 is controlled by an I/O controller to manage input and output signals for computing device 2100. In some cases, I/O interface 2120 manages peripherals not integrated into computing device 2100. In some cases, I/O interface 2120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2120 or via hardware components controlled by the I/O controller.

According to some aspects, user interface component(s) 2125 enable a user to interact with computing device 2100. In some cases, user interface component(s) 2125 include an audio device, such as an external speaker system, an external display device such as a display screen, an input device (e.g., a remote-control device interfaced with a user interface directly or through the I/O controller), or a combination thereof. In some cases, user interface component(s) 2125 include a GUI.

Performance of apparatus, systems and methods of the present disclosure have been evaluated, and results indicate embodiments of the present disclosure have obtained increased performance over existing technology. Example experiments demonstrate that the image generation apparatus described in embodiments of the present disclosure outperforms conventional systems.

Embodiments of the present disclosure provide a joint framework for creating character-consistent text-to-image generation, inpainting, and content insertion. The unified model (as described in FIGS. 8 and 12-13) works interchangeably across various modes of operation, including content-consistent inpainting and generative fill. By integrating different modes, the unified model facilitates seamless switching between inpainting and background generation during the diffusion process, which enhances the ability to prioritize character consistency or object harmonization. Furthermore, since original conditions of the U-Net (including text and CLIP embedding guidance) are preserved, text-to-image generation, style transfer, and other aesthetic improvements available in the base model are maintained while adding enhanced content consistency.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an object prompt and a background prompt, wherein the object prompt describes an object with a target effect and the background prompt describes a scene;
generating a noise input based on the object prompt and the background prompt, wherein the noise input indicates a location of the object within the scene; and
generating, using an image generation model, a synthetic image based on the object prompt, the background prompt, and the noise input, wherein the synthetic image depicts the object at the location within the scene with the target effect applied to the object.

2. The method of claim 1, wherein obtaining the object prompt comprises:
obtaining a preliminary image depicting the object; and
removing a background from the preliminary image to obtain the object prompt.

3. The method of claim 1, further comprising:
obtaining an object mask indicating the location of the object in the scene, wherein the noise input includes a channel corresponding to the object mask.

4. The method of claim 1, wherein generating the synthetic image comprises:
denoising the noise input based on the object prompt.

5. The method of claim 1, further comprising:
encoding the object prompt to obtain an identity embedding, wherein the synthetic image is generated based on the identity embedding.

6. The method of claim 1, further comprising:
encoding the background prompt to obtain a background embedding, wherein the synthetic image is generated based on the background embedding.

7. The method of claim 1, further comprising:
encoding the object prompt to obtain a text embedding, wherein the synthetic image is generated based on the text embedding.

8. The method of claim 1, wherein generating the synthetic image comprises:
obtaining an identity preservation value; and
combining a first attention weight corresponding to a reference image of the object prompt and a second attention weight corresponding to a text prompt of the object prompt based on the identity preservation value.

9. A method comprising:
obtaining a training set including a training reference image and a training text prompt, wherein the training reference image depicts an object and the training text prompt describes a target effect for the object;
generating a noise input based on the training reference image and the training text prompt, wherein the noise input indicates a location of the object; and
training, using the training set, an image generation model to generate a synthetic image based on the noise input, wherein the synthetic image depicts the object at the location with the target effect applied to the object.

10. The method of claim 9, wherein obtaining the training set comprises:
obtaining a preliminary image depicting the object; and
removing a background from the preliminary image to obtain the training reference image.

11. The method of claim 9, wherein:
the noise input is generated based on the object and a ground-truth image, wherein the noise input indicates the location of the object within a scene from the ground-truth image.

12. The method of claim 9, wherein generating the noise input further comprises:
obtaining an object mask indicating the location of the object within a scene from a ground-truth image, wherein the noise input includes a channel corresponding to the object mask.

13. The method of claim 12, further comprising:
identifying a pre-determined dropping ratio; and
dropping the object mask based on the pre-determined dropping ratio by setting values of the object mask to zeros.

14. The method of claim 9, wherein training the image generation model comprises:
generating an intermediate output image;
computing a reconstruction loss between the intermediate output image and a ground-truth image; and
updating parameters of the image generation model based on the reconstruction loss.

15. The method of claim 9, further comprising:
jointly training the image generation model, an identity encoder, a text encoder, and an image encoder.

16. A system comprising:
a memory component; and
a processing device coupled to the memory component, the processing device configured to perform operations comprising:
generating a noise input based on a reference image and a background image, wherein the noise input indicates a location of an object from the reference image within a scene from the background image; and
generating, using an image generation model, a synthetic image based on the reference image, a text prompt, the background image, and the noise input, wherein the synthetic image depicts the object at the location within the scene with a target effect from the text prompt applied to the object.

17. The system of claim 16, wherein the processing device is further configured to perform operations comprising:
encoding, using an identity encoder, the reference image to obtain an identity embedding, wherein the synthetic image is generated based on the identity embedding.

18. The system of claim 16, wherein the processing device is further configured to perform operations comprising:
encoding, using a text encoder, the text prompt to obtain a text embedding, wherein the synthetic image is generated based on the text embedding.

19. The system of claim 16, wherein the processing device is further configured to perform operations comprising:
encoding, using an image encoder, the background image to obtain a background embedding, wherein the synthetic image is generated based on the background embedding.

20. The system of claim 16, wherein:
the image generation model comprises a diffusion model.
